(19) United States
(12) Patent Application Publication
(10) Pub. No.: US 2024/0043639 A1
(43) Pub. Date: Feb. 8, 2024

(54) CURED FILM AND LAMINATED BODY

(71) Applicant: SUMITOMO CHEMICAL COMPANY, LIMITED, Tokyo (JP)

(72) Inventors: Michiru DAIMON, Osaka-shi (JP); Sayaka SAKURAI, Tokyo (JP); Tomohiro ITO, Osaka-shi (JP)

(73) Assignee: SUMITOMO CHEMICAL COMPANY, LIMITED, Tokyo (JP)

(21) Appl. No.: 18/039,133

(22) PCT Filed: Jan. 21, 2022
(86) PCT No.: PCT/JP2022/002094

§ 371 Date: May 26, 2023

(30) Foreign Application Priority Data
Feb. 5, 2021 (JP) 2021-017843

(51) Int. Cl. C08J 7/04

(52) U.S. Cl. CPC C08J 7/04; C08J 2383/08

(57) ABSTRACT

The present invention provides a cured film of a mixed composition of an organosilicon compound (A) including a fluoropolyether structure and an organosilicon compound (C) having an amino group or an amine skeleton, in which, when the elements constituting one side surface (W) of the cured film and amounts thereof are measured by X-ray photoelectron spectroscopy (XPS), the cured film has an F content of 60 atom % or more and an O content of 17 atom % or more.

### TECHNICAL FIELD

The present invention relates to a cured film and a laminated body.

### BACKGROUND ART

Films formed from compositions containing compounds having a fluoropolyether structure are used as antifouling coatings, water repellent and oil repellent coatings, or other applications in a variety of fields, including display devices such as touch panel displays, optical elements, semiconductor elements, construction materials, and window glass for automobiles and buildings since their surface free energy is very small.

When applying a composition containing a compound having a fluoropolyether structure to a substrate, a primer layer may be formed on the substrate in advance and then the composition may be applied to form an antifouling coating or a water repellent and oil repellent coating.

For example, Patent Literature 1 discloses a method for producing an antifouling article having a substrate whose surface is at least partially composed of an organic material, a primer layer provided on the surface composed of the organic material, and an antifouling layer provided on the primer layer, the method including: applying a composition for primer layers containing a predetermined first silane compound and a first solvent onto the surface composed of the organic material; allowing the first silane compound to react to obtain a primer layer; attaching a composition for antifouling layers containing a second silane compound having a perfluoropolyether group and a hydrolyzable silyl group on the primer layer; and allowing the second silane compound to react to obtain an antifouling layer.

Also, Patent Literature 2 discloses that a predetermined organosilicon compound (A) having a perfluoropolyether structure and a fluorinated solvent (D) are mixed, N-2-(aminoethyl)-3-aminopropyltrimethoxysilane is further added dropwise to obtain a solution for film formation, and the obtained solution is applied onto a substrate and baked to obtain a transparent film.

### CITATION LIST

### Patent Literature

[Patent Literature 1] International Publication No. WO 2018/207811
[Patent Literature 2] Japanese Patent Laid-Open No. 2019-085567

### SUMMARY OF INVENTION

### Technical Problem

In the above Patent Literature 1, the primer layer is formed on the substrate, and then the antifouling layer is formed on the primer layer. In this regard, in Patent Literature 2, the film is formed by applying the solution for film formation to the substrate, and the film is formed with fewer steps compared to Patent Literature 1.

However, as a result of investigations by the present inventors, it was found that there is room for improvement in wear resistance of the antifouling layer presented in the above Patent Literature 2.

Therefore, an object of the present invention is to provide a film having a fluoropolyether structure that can be formed in one step and that has excellent wear resistance.

### Solution to Problem

The present invention, which achieves the above object, is as follows.

[1] A cured film of a mixed composition of an organosilicon compound (A) including a fluoropolyether structure and an organosilicon compound (C) having an amino group or an amine skeleton,
wherein, when the elements constituting one side surface (W) of the cured film and amounts thereof are measured by X-ray photoelectron spectroscopy (XPS), the cured film has an F content of 60 atom % or more and an O content of 17 atom % or more.
   [2] The cured film described in [1], wherein, when the elements constituting the surface (W) and elemental amounts thereof are measured by PAR-XPS and the spectrum of each element is analyzed, oxygen atoms contained in a CF×O structure are 10 atom % or more relative to all elements, as determined by analyzing the spectrum of oxygen (O1s).

[3] The cured film described in [1] or [2], wherein, when the ratio percentage Q: A^{F}_{C-F}/A^{N}_{C-N}×100 (atom %) of the amount of F atoms as C—F (in terms of amount of substance): A^{F}_{C-F} to the amount of N atoms as C—N (in terms of amount of substance): A^{N}_{C-N} is determined at a depth of 0.5 nm and a depth of 1.5 nm from the surface (W), Q_{0.5nm} (atom %) at a depth of 0.5 nm is 1000 (atom %) or more larger than Q_{1.5nm} (atom %) at a depth of 1.5 nm.

[4] The cured film described in any one of [1] to [3], having a film thickness of less than 15 nm.

[5] The cured film described in any one of [1] to [4], wherein the surface (W) has a surface arithmetic mean roughness Ra of 40 nm or less, as calculated in accordance with JIS B0601.

[6] The cured film described in any one of [1] to [5], wherein the contact angle of water on the surface (W) is 113° or more.

[7] A laminated body including a substrate (s) and the cured film described in any one of [1] to [6].

[8] The laminated body described in [7], wherein the substrate (s) and the cured film are laminated via a layer (X) formed from at least one selected from the group consisting of an acrylic resin, a silicone resin, a styrene resin, a vinyl chloride resin, a polyamide resin, a phenolic resin, an epoxy resin, and SiO₂.

[9] A window film or touch panel display including the laminated body described in [7] or [8].

### Advantageous Effects of Invention

The cured film of the present invention can be formed in one step, and also has excellent wear resistance since the F content and the O content on the film surface are at or above a certain level.

### DESCRIPTION OF EMBODIMENTS

A cured film of the present invention is a cured film of a mixed composition of an organosilicon compound (A) including a fluoropolyether structure and an organosilicon compound (C) having an amino group or an amine skeleton, in which, when the elements constituting one side surface (W) of the cured film and amounts thereof are measured by X-ray photoelectron spectroscopy (XPS), the cured film has an F content of 60 atom % or more and an O content of 17 atom % or more.

1. Mixed Composition

The mixed composition of an organosilicon compound (A) including a fluoropolyether structure and an organosilicon compound (C) having an amino group or an amine skeleton is obtained by mixing the organosilicon compound (A) and the organosilicon compound (C), and also includes one in which the reaction has progressed after mixing them, for example, during storage. In the mixed composition, at least one of a fluorinated solvent (D1) and a non-fluorinated solvent (D2) may be mixed in, and both the fluorinated solvent (D1) and the non-fluorinated solvent (D2) may be mixed in. Also, in the mixed composition, an organosilicon compound (B) may be further mixed in, if necessary.

1-1. Organosilicon Compound (A)

The organosilicon compound (A) includes a fluoropolyether structure. The fluoropolyether structure can also be referred to as a fluorooxyalkylene group, meaning a structure with oxygen atoms at both ends. The fluoropolyether structure has liquid repellency such as water repellency or oil repellency. It is preferable that the fluoropolyether structure be a perfluoropolyether structure. The number of carbon atoms contained in the longest linear moiety of the fluoropolyether structure is preferably 5 or more, for example, more preferably 10 or more, and even more preferably 20 or more. The upper limit of the number of carbon atoms is not particularly limited, and it is, for example, 200, preferably 150. The number of silicon atoms in one molecule of the organosilicon compound (A) is preferably 1 to 10, and more preferably 1 to 6.

It is preferable that the organosilicon compound (A) contain, in addition to the fluoropolyether structure and silicon atoms, a hydrolyzable group or a hydroxy group (hereinafter, both of which are collectively referred to as a reactive group (k)), and it is more preferable that the reactive group (k) be bonded to the silicon atom via a linking group or without a linking group. The reactive group (k) has the action of being bonded through hydrolysis and dehydration condensation reactions together with the organosilicon compounds (A); the organosilicon compound (A) and another monomer; or the organosilicon compound (A) and the active hydrogen (hydroxy group or others) on the surface to which the above mixed composition is to be applied, through condensation reaction. Examples of the hydrolyzable group include an alkoxy group, a halogen atom, a cyano group, an acetoxy group, and an isocyanate group. It is preferable that the reactive group (k) be an alkoxy group or a halogen atom, it is more preferable that it be an alkoxy group having 1 to 4 carbon atoms or a chlorine atom, and it is particularly preferable that it be a methoxy group or an ethoxy group.

In an aspect where the organosilicon compound (A) contains the fluoropolyether structure, silicon atoms, and the reactive group (k), it is preferable that a monovalent group having an oxygen atom of the fluoropolyether structure at the end of the bonding hand side (hereinafter, referred to as a FPE group) be bonded to a silicon atom via a linking group or without a linking group, and that a silicon atom be bonded to the reactive group (k) via a linking group or without a linking group. In the case where the FPE group and a silicon atom are bonded via a linking group, one or a plurality of silicon atoms to which the reactive group (k) is bonded via a linking group or without a linking group may be present in one molecule of the organosilicon compound (A), and the number thereof is, for example, 1 or more and 10 or less.

The FPE group may be linear or may have a side chain, and it is preferable to have a side chain. As an aspect of having a side chain, in particular, it is preferable that the fluoropolyether structure in the FPE group have a side chain. It is preferable to have a fluoroalkyl group as a side chain, and the fluoroalkyl group is more preferably a perfluoroalkyl group, and still more preferably a trifluoromethyl group. The number of carbon atoms in the linking group that links the FPE group to a silicon atom is, for example, 1 or more and 20 or less, preferably 2 or more and 15 or less. It is preferable that the aforementioned FPE group be a group in which a fluorine-containing group having a fluoroalkyl group at the end and a perfluoropolyether structure are directly bonded. The fluorine-containing group may be a fluoroalkyl group or may be a fluoroalkyl group to which a linking group such as a divalent aromatic hydrocarbon group is bonded, but it is preferable that it be a fluoroalkyl group. It is preferable that the fluoroalkyl group be a perfluoroalkyl group, and it is more preferable that it be a perfluoroalkyl group having 1 to 20 carbon atoms.

Examples of the fluorine-containing group include CF₃(CF₂)ₚ— (p is 1 to 19, for example, and preferably 1 to CF₃(CF₂)ₘ—(CH₂)ₙ— and CF₃(CF₂)ₘ—C₆H₄— (in both cases, m is 1 to 10, preferably 3 to 7, and in both cases, n is 1 to 5, preferably 2 to 4), and CF₃(CF₂)ₚ— or CF₃(CF₂)ₘ—(CH₂)ₙ— is preferred.

The reactive group (k) may be bonded to a silicon atom via a linking group, or may be directly bonded to a silicon atom without a linking group, and it is preferable that it be directly bonded to a silicon atom. The number of reactive groups (k) bonded to one silicon atom may be one or more, may be 2 or 3, but 2 or 3 is preferred, and 3 is particularly preferred. In the case where two or more reactive groups (k) are bonded to a silicon atom, different reactive groups (k) may be bonded to the silicon atom, but it is preferable that the same reactive groups (k) be bonded to the silicon atom. In the case where the number of reactive groups (k) bonded to one silicon atom is 2 or less, a monovalent group other than the reactive group (k) may be bonded to the remaining bonding hand, and for example, an alkyl group (in particular, an alkyl group having 1 to 4 carbon atoms), H, NCO, and others can be bonded.

It is preferable that the organosilicon compound (A) be a compound represented by the following formula (a1).

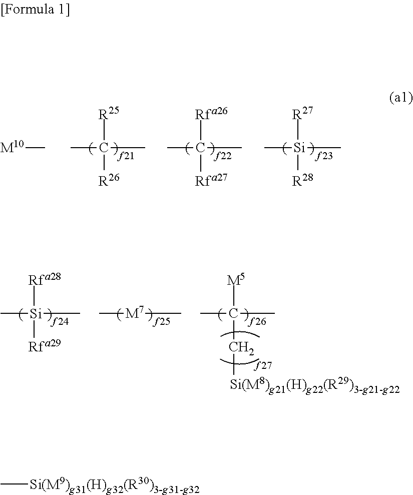

In the above formula (a1),

Rf^{a26}, Rf^{a27}, Rf^{a28}, and Rf^{a29} are each independently a fluorinated alkyl group having 1 to 20 carbon atoms in which one or more hydrogen atoms are replaced by fluorine atoms, or a fluorine atom, and when there is a plurality of Rf^{a26}, the plurality of Rf^{a26} is optionally different from each other, when there is a plurality of Rf^{a27}, the plurality of Rf^{a27} is optionally different from each other, when there is a plurality of Rf^{a28}, the plurality of Rf^{a28} is optionally different from each other, and when there is a plurality of Rf^{a29}, the plurality of Rf^{a29} is optionally different from each other;

R²⁵ and R²⁶ are each independently a hydrogen atom, a halogen atom, an alkyl group having 1 to 4 carbon atoms, or a halogenated alkyl group having 1 to 4 carbon atoms in which one or more hydrogen atoms are replaced by halogen atoms, at least one of R²⁵ and R²⁶ bonded to one carbon atom is a hydrogen atom, and when there is a plurality of R²⁵, the plurality of R²⁵ is optionally different from each other and when there is a plurality of R²⁶, the plurality of R²⁶ is optionally different from each other;

R²⁷ and R²⁸ are each independently a hydrogen atom, an alkyl group having 1 to 4 carbon atoms, or a single bond, and when there is a plurality of R²⁷, the plurality of R²⁷ is optionally different from each other and when there is a plurality of R²⁸, the plurality of R²⁸ is optionally different from each other;

R²⁹ and R³⁰ are each independently an alkyl group having 1 to 20 carbon atoms, and when there is a plurality of R²⁹, the plurality of R²⁹ is optionally different from each other and when there is a plurality of R³⁰, the plurality of R³⁰ is optionally different from each other;

M⁷ is —O—, —C(═O)—O—, —O—C(═O)—, —NR—, —NRC(═O)—, —C(═O)NR—, —CH═CH—, or —C₆H₄— (phenylene group), where R is a hydrogen atom, an alkyl group having 1 to 4 carbon atoms, or a fluorine-containing alkyl group having 1 to 4 carbon atoms, and when there is a plurality of M⁷, the plurality of M⁷ is optionally different from each other;

M⁵ is a hydrogen atom, a fluorine atom, or an alkyl group having 1 to 4 carbon atoms, and when there is a plurality of M⁵, the plurality of M⁵ is optionally different from each other;

M¹⁰ is a hydrogen atom or a halogen atom;

M⁸ and M⁹ are each independently a hydrolyzable group, a hydroxy group, or —(CH₂)ₑ₇—Si(OR¹⁴)³, where e7 is 1 to 5 and R 14 is a methyl group or an ethyl group, and when there is a plurality of M⁸, the plurality of M⁸ is optionally different from each other and when there is a plurality of M⁹, the plurality of M⁹ is optionally different from each other;

f21, f22, f23, f24, and f25 are each independently an integer of 0 to 600, and the total value of f21, f22, f23, f24, and f25 is 13 or more;

f26 is an integer of 0 to 20;

f27 is each independently an integer of 0 to 2;

g21 is an integer of 1 to 3, g22 is an integer of 0 to 2, and g21+g22≤3;

g31 is an integer of 1 to 3, g32 is an integer of 0 to 2, and g31+g32≤3; and

as for M¹⁰-, —Si(M⁹)_{g31}(H)_{g32}(R³⁰)_{3-g31-g32}, f21 —{C(R²⁵)(R²⁶)}— units (Uₐ₁), f22 —{C(Rf^{a26})(Rf^{a27})}— units (Uₐ₂), f23 —{Si(R²⁷)(R²⁸)}— units (Uₐ₃), f24 —{Si(Rf^{a28})(Rf^{a29})}— units (Uₐ₄), f25 -M⁷- units (Uₐ₅), and f26 —[C(M⁵){(CH₂)_{f27}—Si(M⁸)_{g21}(H)_{g22}(R²⁹)_{3-g21-g22}}] units (Uₐ₆), each unit is arranged and bonded in any order as long as is one end in formula (a1), —Si(M⁹)_{g31}(H)_{g32}(R³⁰)_{3-g31-g32} is the other end, they are arranged in an order that at least partially forms the fluoropolyether structure, and —O— is not consecutive to —O—. Being arranged and bonded in any order means that it is not limited to the meaning that each repeating unit is consecutively arranged in the same order as described in the above formula (a1), and also means that f21 —{C(R²⁵)(R²⁶)}-units (Uₐ₁) are not necessarily consecutively bonded, but may be bonded via other units in the middle so that there are f21 units in total. The same applies to units (Uₐ₂) to (Uₐ₆) bracketed by f22 to f26, respectively.

In addition, in the case where at least one of R²⁷ and R²⁸ is a single bond, the single bond moiety of a unit bracketed by f23 and —O— in M⁷ can be repeatedly bonded to form branched or cyclic siloxane bonds.

It is preferable that Rf^{a26}, Rf^{a27}, Rf^{a28}, and Rf^{a29} be preferably each independently a fluorine atom or a fluorinated alkyl group having 1 to 2 carbon atoms in which one or more hydrogen atoms are replaced by fluorine atoms, and it is more preferable that they be each a fluorine atom or a fluorinated alkyl group having 1 to 2 carbon atoms in which all hydrogen atoms are replaced by fluorine atoms.

R²⁵ and R²⁶ are preferably each independently a hydrogen atom or a fluorine atom, and at least one of R²⁵ and R²⁶ bonded to one carbon atom is a hydrogen atom, and more preferably they are both hydrogen atoms.

R²⁷ and R²⁸ are preferably each independently a hydrogen atom or an alkyl group having 1 to 2 carbon atoms, and more preferably they are all hydrogen atoms.

R²⁹ and R³⁰ are each preferably an alkyl group having 1 to 5 carbon atoms, and more preferably an alkyl group having 1 to 2 carbon atoms.

M⁷ is preferably —C(═O)—O—, —O—, or —O—C(═O)—, and more preferably all —O—.

M⁵ is preferably a hydrogen atom or an alkyl group having 1 to 2 carbon atoms, and more preferably all hydrogen atoms.

M¹⁰ is more preferably a fluorine atom.

M⁸ and M⁹ are more preferably each independently an alkoxy group or a halogen atom, more preferably a methoxy group, an ethoxy group, or a chlorine atom, and particularly preferably a methoxy group or an ethoxy group.

Preferably, f21, f23, and f24 are each ½ of f22 or less, more preferably ¼ or less, still more preferably f23 or f24 is 0, and particularly preferably f23 and f24 are 0.

f25 is preferably ⅕ or more of the total value of f21, f22, f23, and f24, and not more than the total value of f21, f22, f23, and f24.

f21 is preferably 0 to 20, more preferably 0 to 15, still more preferably 1 to 15, and particularly preferably 2 to 10. f22 is preferably 5 to 600, more preferably 8 to 600, still more preferably 20 to 200, further preferably 30 to 200, still further preferably 35 to 180, and most preferably 40 to 180. f23 and f24 are each preferably 0 to 5, more preferably 0 to 3, and still more preferably 0. f25 is preferably 4 to 600, more preferably 4 to 200, still more preferably 10 to 200, and further preferably 30 to 60. The total value of f21, f22, f23, f24, and f25 is preferably 20 to 600, more preferably 20 to 250, and still more preferably 50 to 230. f26 is preferably 0 to 18, more preferably 0 to 15, still more preferably 0 to 10, and further preferably 0 to 5. f27 is preferably 0 to 1, and preferably 0. g21 and g31 are each independently preferably 2 to 3, and more preferably 3. g22 and g32 are each independently preferably 0 or 1, and more preferably 0. It is preferable that g21+g22 and g31+g32 be each 3.

It is preferable to use as the organosilicon compound (A) a compound (a11) in which R²⁵ and R²⁶ are both hydrogen atoms; Rf^{a26} and Rf^{a27} are each a fluorine atom or a fluorinated alkyl group having 1 to 2 carbon atoms in which all hydrogen atoms are replaced by fluorine atoms; M⁷ is all —O—; M⁸ and M⁹ are all methoxy groups, ethoxy groups, or chlorine atoms (in particular, methoxy groups or ethoxy groups); M⁵ is a hydrogen atom; M¹⁰ is a fluorine atom; f21 is 1 to 10 (preferably 2 to 7); f22 is 30 to 200 (more preferably 40 to 180); f23 and f24 are each 0; f25 is 30 to 60; f26 is 0 to 6; f27 is 0 to 1 (particularly preferably 0); g21 and g31 are each 1 to 3 (both preferably 2 or more, and more preferably 3); g22 and g32 are each 0 to 2 (both preferably 0 or 1, and more preferably 0); and g21+g22 and g31+g32 are each 3 in the above formula (a1).

It is preferable that the organosilicon compound (A) be represented by the following formula (a2).

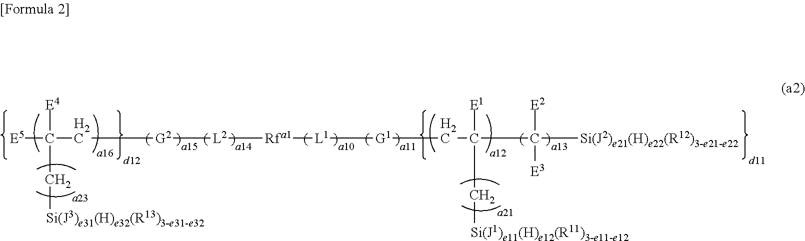

In the above formula (a2),

Rf^{a1} is a divalent fluoropolyether structure with oxygen atoms at both ends;

R¹¹, R¹², and R¹³ are each independently an alkyl group having 1 to 20 carbon atoms, and when there is a plurality of R¹¹, the plurality of R¹¹ is optionally different from each other, when there is a plurality of R¹², the plurality of R¹² is optionally different from each other, and when there is a plurality of R¹³, the plurality of R¹³ is optionally different from each other;

E¹, E², E³, E⁴, and E⁵ are each independently a hydrogen atom or a fluorine atom, and when there is a plurality of E¹, the plurality of E¹ is optionally different from each other, when there is a plurality of E², the plurality of E² is optionally different from each other, when there is a plurality of E³, the plurality of E³ is optionally different from each other, when there is a plurality of E⁴, the plurality of E⁴ is optionally different from each other, and when there is a plurality of E⁵, the plurality of E⁵ is optionally different from each other;

G¹ and G² are each independently a divalent to 10-valent organosiloxane group having a siloxane bond;

J¹, J², and J³ are each independently a hydrolyzable group, a hydroxy group, or —(CH₂)ₑ₇—Si(OR¹⁴)₃, where e7 is 1 to 5, R¹⁴ is a methyl group or an ethyl group, and when there is a plurality of J¹, the plurality of J¹ is optionally different from each other, when there is a plurality of J², the plurality of J² is optionally different from each other, and when there is a plurality of J³, the plurality of J³ is optionally different from each other;

L¹ and L² are each independently a divalent linking group having 1 to 12 carbon atoms and optionally containing an oxygen atom, a nitrogen atom, a silicon atom, or a fluorine atom, in which one or more of —{C(R²⁵)(R²⁶)}— units (Uₐ₁), —{C(Rf^{a26})(Rf^{a27})}-units (Uₐ₂), —{Si(R²⁷)(R²⁸)}— units (Uₐ₃), or -M⁷- units (Uₐ₅) are arranged and bonded in any order (R²⁵, R²⁶, R²⁷, R²⁸, Rf^{a26}, Rf^{a27}, and M⁷ are the same as in the above formula (a1));

a¹⁰ and a¹⁴ are each independently 0 or 1;

a¹¹ and a¹⁵ are each independently 0 or 1;

a¹² and a¹⁶ are each independently 0 to 9;

a¹³ is 0 to 4;

when a11 is 0 or when a11 is 1 and G¹ is divalent, then d11 is 1, and when a11 is 1 and G¹ is trivalent to then d11 is a number that is one less than the valence of G¹;

when a15 is 0 or when a15 is 1 and G 2 is divalent, then d12 is 1, and when a15 is 1 and G 2 is trivalent to then d12 is a number that is one less than the valence of G 2;

a21 and a23 are each independently 0 to 2;

e11 is 1 to 3, e12 is 0 to 2, and e11+e12≤3;

e21 is 1 to 3, e22 is 0 to 2, and e21+e22≤3; and

e31 is 1 to 3, e32 is 0 to 2, and e31+e32≤3.

Note that a10 being 0 means that the moiety bracketed with a10 is a single bond, and the same applies when a11, a12, a13, a14, a15, a16, a21, or a23 is 0.

Rf^{a1} is preferably —O— (CF₂CF₂O)ₑ₄—, —O— (CF₂CF₂CF₂O)ₑ₅—, or —O—(CF₂—CF(CF₃)O)ₑ₆—. e4 and e5 are both 15 to 80, and e6 is 3 to 60. In addition, it is also preferable that Rf^{a1} be a remaining group formed by removing hydrogen atoms from the hydroxy groups at both ends of a structure in which p moles of perfluoropropylene glycol and q moles of perfluoromethanediol are randomly dehydrated and condensed, where p+q is 15 to 80, and this aspect is most preferable as Rf^{a1}.

R¹¹, R¹², and R¹³ are each independently preferably an alkyl group having 1 to 10 carbon atoms, and more preferably an alkyl group having 1 to 2 carbon atoms.

It is preferable that E¹, E², E³, and E⁴ be all hydrogen atoms, and it is preferable that E⁵ be a fluorine atom.

L¹ and L² are each independently preferably a divalent linking group having 1 to 12 (preferably 1 to 10, and more preferably 1 to 5) carbon atoms and containing a fluorine atom, in which one or more of —{C(R²⁵) (R²⁶)}-units (Uₐ₁) or —{C(Rf^{a26})(Rf^{a27})}— units (Uₐ₂) are arranged and bonded in any order, and more preferably —(CF₂)ₓ—, where x is 1 to 12 (preferably 1 to 10, and more preferably 1 to 5).

G¹ and G² are each independently preferably a divalent to pentavalent organosiloxane group having a siloxane bond.

J¹, J², and J³ are each independently preferably a methoxy group, an ethoxy group, or —(CH₂)ₑ₇—Si(OR¹⁴)₃, and more preferably a methoxy group or an ethoxy group.

a10 is preferably 1, a11 is preferably 0, a12 is preferably 0 to 7 and more preferably 0 to 5, a13 is preferably 1 to 3, a14 is preferably 1, a15 is preferably a16 is preferably 0 to 6 and more preferably 0 to 3, a21 and a23 are both preferably 0 or 1 (more preferably both 0), d11 is preferably 1, d12 is preferably 1, e11, e21 and e31 are all preferably 2 or more, also preferably 3. e12, e22, and e32 are all preferably 0 or 1, and more preferably 0. It is preferable that e11+e12, e21+e22, and e31+e32 be all 3. These preferred ranges may be satisfied alone, or two or more of them may be satisfied in combination.

It is preferable to use as the compound (A) a compound (a21) in which Rf^{a1} is a remaining group formed by removing hydrogen atoms from the hydroxy groups at both ends of a structure in which p moles of perfluoropropylene glycol and q moles of perfluoromethanediol are randomly dehydrated and condensed, where p+q is 15 to 80; L¹ and L² are both perfluoroalkylene groups having 1 to 5 (preferably 1 to 3) carbon atoms; E¹, E², and E³ are all hydrogen atoms; E⁴ is a hydrogen atom; E⁵ is a fluorine atom; J¹, J², and J³ are all methoxy groups or ethoxy groups (in particular, methoxy groups); a10 is 1; a11 is 0; a12 is 0 to 7 (preferably 0 to 5); a13 is 2; a14 is 1; a15 is 0; a16 is to 6 (in particular, 0); a21 and a23 are each independently 0 or 1 (more preferably, a21 and a23 are both 0); d11 is 1; d12 is 1; e11, e21, and e31 are all 2 to 3 (in particular, 3); e12, e22, and e32 are all 0 or 1 (in particular, 0); and e11+e12, e21+e22, and e31+e32 are all 3 in the above formula (a2).

It is also preferable to use as the compound (A) a compound (a22) in which Rf^{a1} is −O— (CF₂CF₂CF₂O)ₑ₅—; e5 is 15 to 80 (preferably 25 to 40); L¹ is a divalent linking group having 3 to 6 carbon atoms and containing a fluorine atom and an oxygen atom; L² is a perfluoroalkylene group having 2 to 10 carbon atoms; E² and E³ are both hydrogen atoms; E⁵ is a fluorine atom; J² is —(CH₂)ₑ₇—Si(OCH₃)₃; e7 is 2 to 4; a10 is 1; a11 is 0; a12 is 0; a13 is 2; a14 is 1; a15 is 0; a16 is 0; d11 is 1; d12 is 1; and e21 is 3 in the above formula (a2).

More specifically, examples of the organosilicon compounds (A) include a compound of the following formula (a3).

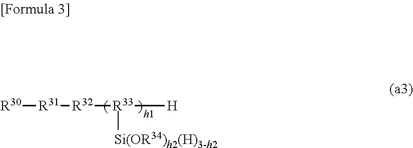

In the above formula (a3), R 30 is a perfluoroalkyl group having 1 to 6 carbon atoms; R 31 is a remaining group formed by removing hydrogen atoms from the hydroxy groups at both ends of a structure in which p moles of perfluoropropylene glycol and q moles of perfluoromethanediol are randomly dehydrated and condensed, where p+q is 15 to 80; R³² is a perfluoroalkylene group having 1 to 10 carbon atoms; R³³ is a trivalent saturated hydrocarbon group having 2 to 6 carbon atoms; and R³⁴ is an alkyl group having 1 to 3 carbon atoms. The number of carbon atoms in R³⁰ is preferably 1 to 4, and more preferably 1 to 3. The number of carbon atoms in R³² is preferably 1 to 5. h1 is 1 to 10, preferably 1 to 8, and more preferably 1 to 6. h2 is 1 or more, preferably 2 or more, and it may be 3.

Examples of the organosilicon compound (A) may also include a compound represented by the following formula (a4).

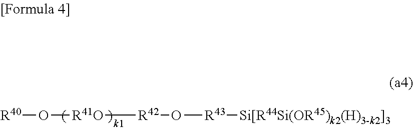

In the above formula (a4), R⁴⁰ is a perfluoroalkyl group having 2 to 5 carbon atoms; R⁴¹ is a perfluoroalkylene group having 2 to 5 carbon atoms; R⁴² is a fluoroalkylene group formed by replacing some of the hydrogen atoms of an alkylene group having 2 to 5 carbon atoms with fluorine; R⁴³ and R⁴⁴ are each independently an alkylene group having 2 to 5 carbon atoms; and R⁴⁵ is a methyl group or an ethyl group. kl is an integer of 1 to 5. k2 is an integer of 1 to 3, preferably 2 or more, and it may be 3.

The number average molecular weight of the organosilicon compound (A) is preferably 2,000 or more, more preferably 4,000 or more, still more preferably or more, further preferably 6,000 or more, and particularly preferably 7,000 or more, and it is also preferably 40,000 or less, more preferably 20,000 or less, and still more preferably 15,000 or less.

As the organosilicon compound (A), only one type may be used, or two or more types may be used.

The amount of the organosilicon compound (A) is preferably 0.01% by mass or more, more preferably 0.02% by mass or more, still more preferably 0.03% by mass or more, further preferably 0.05% by mass or more, and particularly preferably 0.07% by mass or more, and it is also preferably 0.5% by mass or less, and more preferably by mass or less in 100% by mass of the mixed composition. The amount of the organosilicon compound (A) and other compounds that will be described later can be adjusted at the time of preparation of the composition, or may be calculated from the analytical results of the composition. As for the method of identifying from the analytical results of the composition, for example, the type of each compound contained in the composition can be identified by analyzing the composition by gas chromatography-mass spectrometry, liquid chromatography-mass spectrometry, or other methods and searching the obtained analytical results in libraries, and the amount of each compound contained in the composition can also be calculated from the above analytical results by using the calibration curve method.

As mentioned above, the above mixed composition also contains one in which the reaction has progressed after mixing the organosilicon compound (A), the organosilicon compound (C), and the fluorinated solvent (D1) and/or the non-fluorinated solvent (D2), and examples of the reaction that has progressed include a case in which the mixed composition contains a compound in which a hydrolyzable group bonded to a silicon atom of the organosilicon compound (A) (this may be bonded via a linking group) has become a —SiOH group (Si and OH may be bonded via a linking group) due to hydrolysis. Other examples thereof include a case in which the mixed composition contains a condensation product of the organosilicon compound (A), and examples of the condensation product include a condensation product formed by dehydration condensation of a —SiOH group that the organosilicon compound (A) has or a —SiOH group (Si and OH may be bonded via a linking group) of the organosilicon compound (A) generated by hydrolysis with a —SiOH group (Si and OH may be bonded via a linking group) derived from the organosilicon compound (A), or with a —SiOH group derived from another compound.

1-2. Organosilicon Compound (C)

The organosilicon compound (C) is a compound having an amino group or an amine skeleton, and may have both an amino group and an amine skeleton. The amine skeleton is represented by —NR¹⁰⁰—, where R¹⁰⁰ is a hydrogen atom or an alkyl group. It is preferable that a hydrolyzable group or a hydroxy group be bonded to a silicon atom of the organosilicon compound (C). Examples of the hydrolyzable group bonded to a silicon atom of the organosilicon compound (C) include an alkoxy group, a halogen atom, a cyano group, an acetoxy group, and an isocyanate group. It is preferable that an alkoxy group having 1 to 4 carbon atoms or a hydroxy group be bonded to a silicon atom of the organosilicon compound (C), an alkoxy group having 1 to 2 carbon atoms or a hydroxy group is more preferred, and a methoxy group is particularly preferred. The use of the organosilicon compound (C) in the mixed composition can achieve, in a laminated body in which a film obtained from the mixed composition is formed on a substrate, good close adhesion of the film to the substrate, resulting in improved wear resistance of the laminated body.

As the organosilicon compound (C), compounds represented by the following formulas (c1) to (c3) can be exemplified.

1-2-1. Organosilicon Compound (C) Represented by Formula (c1) (Hereinafter, Organosilicon Compound (C1))

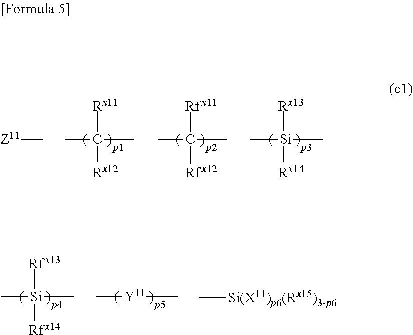

In the above formula (c1),

R^{x11}, R^{x12}, R^{x13}, and R^{x14} are each independently a hydrogen atom or an alkyl group having 1 to 4 carbon atoms, and when there is a plurality of R^{x11}, the plurality of R^{x11} is optionally different from each other, when there is a plurality of R^{x12}, the plurality of R^{x12} is optionally different from each other, when there is a plurality of R^{x13}, the plurality of R^{x13} is optionally different from each other, and when there is a plurality of R^{x14}, the plurality of R^{x14} is optionally different from each other;

Rf^{x11}, Rf^{x12}, Rf^{x13}, and Rf^{x14} are each independently an alkyl group having 1 to 20 carbon atoms in which one or more hydrogen atoms are replaced by fluorine atoms, or a fluorine atom, and when there is a plurality of Rf^{x11}, the plurality of Rf^{x11} is optionally different from each other, when there is a plurality of Rf^{x12}, the plurality of Rf^{x12} is optionally different from each other, when there is a plurality of Rf^{x13}, the plurality of Rf^{x13} is optionally different from each other, and when there is a plurality of Rf^{x14}, the plurality of Rf^{x14} is optionally different from each other;

R^{x15} is an alkyl group having 1 to 20 carbon atoms, and when there is a plurality of R^{x15}, the plurality of R^{x15} is optionally different from each other;

X¹¹ is a hydrolyzable group, and when there is a plurality of X¹¹, the plurality of X¹¹ is optionally different from each other;

Y¹¹ is —NH— or —S—, and when there is a plurality of Y¹¹, the plurality of Y¹¹ is optionally different from each other;

Z¹¹ is a vinyl group, an α-methylvinyl group, a styryl group, a methacryloyl group, an acryloyl group, an amino group, an isocyanate group, an isocyanurate group, an epoxy group, a ureido group, or a mercapto group;

p1 is an integer of 1 to 20, p2, p3, and p4 are each independently an integer of 0 to 10, and p5 is an integer of 0 to 10;

p6 is an integer of 1 to 3;

when Z¹¹ is not an amino group, there is at least one Y¹¹ that is —NH—, and when Y¹¹ is all —S— or when p5 is 0, Z¹¹ is an amino group; and

as for Z¹¹—, —Si(X¹¹)ₚ₆(R^{x15})₃₋ₚ₆, p1 —{C(R^{x11})(R^{x12})}-units (U_{c11}), p2 —{C(Rf^{x11})(Rf^{x12})}— units (U_{c12}), p3 —{Si(R^{x13})(R^{x14})}— units (U_{c13}), p4 —{Si(Rf^{x13})(Rf^{x14})}— units (U_{c14}), and p5 —Y¹¹— units (U_{c15}), each unit is arranged and bonded in any order as long as Z¹¹— is one end of the compound represented by formula (c1), —Si(X¹¹)ₚ₆(R^{x15})₃₋ₚ₆ is the other end, and —O— is not linked to —O—.

It is preferable that R^{x11}, R^{x12}, R^{x13}, and R^{x14} be each a hydrogen atom.

It is preferable that Rf^{x11}, Rf^{x12}, Rf^{x13}, and Rf^{x14} be each independently an alkyl group having 1 to 10 carbon atoms in which one or more hydrogen atoms are replaced by fluorine atoms, or a fluorine atom.

It is preferable that R^{x15} be an alkyl group having 1 to 5 carbon atoms.

It is preferable that X¹¹ be an alkoxy group, a halogen atom, a cyano group, or an isocyanate group, it is more preferable that it be an alkoxy group, it is still more preferable that it be an alkoxy group having 1 to 4 carbon atoms, it is further preferable that it be a methoxy group or an ethoxy group, and it is particularly preferable that it be a methoxy group.

It is preferable that Y¹¹ be —NH—.

It is preferable that Z¹¹ be a methacryloyl group, an acryloyl group, a mercapto group, or an amino group, it is more preferable that it be a mercapto group or an amino group, and it is still more preferable that it be an amino group.

p1 is preferably 1 to 15, and more preferably 2 to Preferably, p2, p3, and p4 are each independently 0 to 5, and more preferably, they are all 0 to 2. p5 is preferably 0 to 5, more preferably 0 to 3. p6 is preferably 2 to 3, and more preferably 3.

As the organosilicon compound (C), it is preferable to use a compound in which R^{x1} and R^{x12} are both hydrogen atoms; Y¹¹ is —NH—; X¹¹ is an alkoxy group (a methoxy group or an ethoxy group is preferred, and a methoxy group is particularly preferred); Z¹¹ is an amino group or a mercapto group; p1 is 1 to 10; p2, p3, and p4 are all 0; p5 is 0 to 5 (in particular 0 to 3); and p6 is 3 in the above formula (c1).

Note that, as for p1 —{C(R^{x11})(R^{x2})}— units (U_{c11}), —{C(R^{x11})(R^{x2})} are not necessarily consecutively bonded, and they may be bonded via other units in the middle, as long as there are p1 units in total. The same applies to units bracketed by p2 to p5, respectively.

It is preferable that the organosilicon compound (C1) be represented by the following formula (c1-2).

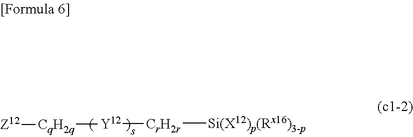

In the above formula (c1-2),

X¹² is a hydrolyzable group, and when there is a plurality of X¹², the plurality of X¹² is optionally different from each other;

Y¹² is —NH—;

Z¹² is an amino group or a mercapto group;

R^{x16} is an alkyl group having 1 to 20 carbon atoms, and when there is a plurality of R^{x16}, the plurality of R^{x16} is optionally different from each other;

p is an integer of 1 to 3, q is an integer of 2 to 5, r is an integer of 0 to 5, and s is 0 or 1; and

when s is 0, Z¹² is an amino group.

It is preferable that X¹² be an alkoxy group, a halogen atom, a cyano group, or an isocyanate group, it is more preferable that it be an alkoxy group, it is still more preferable that it be an alkoxy group having 1 to 4 carbon atoms, it is further preferable that it be a methoxy group or an ethoxy group, and it is most preferable that it be a methoxy group.

It is preferable that Z¹² be an amino group.

It is preferable that R^{x16} be an alkyl group having 1 to 10 carbon atoms, and it is more preferable that it be an alkyl group having 1 to 5 carbon atoms.

It is preferable that p be an integer of 2 to 3, and it is more preferable that it be 3.

When s is 1, it is preferable that q be an integer of 2 to 3 and r be an integer of 2 to 4, and when s is 0, it is preferable that the total of q and r be 1 to 5.

1-2-2. Organosilicon Compound (C) Represented by the Formula (c2) (Hereinafter, Organosilicon Compound (C2))

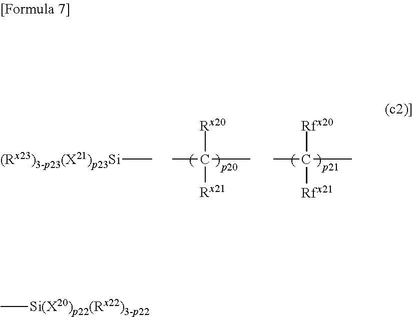

In the above formula (c2),

R^{x20} and R^{x21} are each independently a hydrogen atom or an alkyl group having 1 to 4 carbon atoms, and when there is a plurality of R^{x20}, the plurality of R^{x20} is optionally different from each other and when there is a plurality of R^{x21}, the plurality of R^{x21} is optionally different from each other;

Rf^{x20} and Rf^{x21} are each independently an alkyl group having 1 to 20 carbon atoms in which one or more hydrogen atoms are replaced by fluorine atoms, or a fluorine atom, and when there is a plurality of Rf^{x20}, the plurality of Rf^{x20} is optionally different from each other and when there is a plurality of Rf^{x21}, the plurality of Rf^{x21} is optionally different from each other;

R^{x22} and R^{x23} are each independently an alkyl group having 1 to 20 carbon atoms, and when there is a plurality of R^{x22} and R^{x23}, the plurality of R^{x22} and R^{x23} is optionally different from each other;

X²⁰ and X²¹ are each independently a hydrolyzable group, and when there is a plurality of X²⁰ and X²¹, the plurality of X²⁰ and X²¹ is optionally different from each other;

p20 is an integer of 1 to 30, p21 is an integer of 0 to 30, and at least one of repeating units in parentheses subscripted with p20 or p21 is replaced by an amine skeleton —NR¹⁰⁰—, where R¹⁰⁰ in the amine skeleton is a hydrogen atom or an alkyl group;

p22 and p23 are each independently an integer of 1 to 3; and

as for p20 —{C(R^{x20})(R^{x21})}— units (U_{c20}) and p21 —{C(Rf^{x20})(Rf^{x21})}— units (U_{c21}), p20 units (U_{c20}) or p21 units (U_{c21}) are not necessarily consecutive, but each unit (U_{c21}) and unit (U_{c20}) is arranged and bonded in any order, and one end of the compound represented by formula (c2) is —Si(X²⁰)ₚ₂₂(R^{x22})₃₋ₚ₂₂ and the other end is —Si(X²¹)ₚ₂₃(R^{x23})₃₋ₚ₂₃.

It is preferable that R^{x20} and R^{x21} be each a hydrogen atom.

It is preferable that Rf^{x20} and Rf^{x21} be each independently an alkyl group having 1 to 10 carbon atoms in which one or more hydrogen atoms are replaced by fluorine atoms, or a fluorine atom.

It is preferable that R^{x22} and R^{x23} be each an alkyl group having 1 to 5 carbon atoms.

It is preferable that X²⁰ and X²¹ be each an alkoxy group, a halogen atom, a cyano group, or an isocyanate group, it is more preferable that they be each an alkoxy group, it is still more preferable that they be each an alkoxy group having 1 to 4 carbon atoms, it is even more preferable that they be each a methoxy group or an ethoxy group, and it is particularly preferable that they be each a methoxy group.

The amine skeleton —NR¹⁰⁰— only needs to be present at least once in the molecule as described above and any of the repeating units in parentheses subscripted with p20 or p21 may be replaced by the amine skeleton, but it is preferable that it be part of the repeating units in parentheses subscripted with p20. The amine skeleton may be present in plurality, in which case it is preferable that the number of amine skeletons be 1 to 10, it is more preferable that it be 1 to 5, and it is still more preferable that it be 2 to 5. Also, in this case, it is preferable that the compound have —{C(R^{x20})(R^{x21})}ₚ₂₀₀-between adjacent amine skeletons, where it is preferable that p200 be 1 to 10 and it is more preferable that it be 1 to 5. p200 is included in the total number of p20.

When R¹⁰⁰ in the amine skeleton —NR¹⁰⁰— is an alkyl group, it is preferable that the number of carbon atoms be 5 or less and it is more preferable that it be 3 or less. It is preferable that the amine skeleton —NR¹⁰⁰— be —NH— (R¹⁰⁰ be a hydrogen atom).

p20 is preferably 1 to 15, and more preferably 1 to 10, except for the number of repeating units replaced by the amine skeleton.

p21 is preferably 0 to 5, and more preferably 0 to 2, except for the number of repeating units replaced by the amine skeleton.

p22 and p23 are each preferably 2 to 3, and more preferably 3.

As the organosilicon compound (C2), it is preferable to use a compound in which R^{x20} and R^{x21} are both hydrogen atoms; X²⁰ and X²¹ are each an alkoxy group (a methoxy group or an ethoxy group is preferred, and a methoxy group is particularly preferred); at least one of the repeating units in parentheses subscripted with p20 is replaced by the amine skeleton —NR¹⁰⁰—; R¹⁰⁰ is a hydrogen atom; p20 is 1 to 10 (provided that the number of repeating units replaced by the amine skeleton is excluded); p21 is 0; p22 and p23 are each 3 in the above formula (c2).

Note that, when a reaction product of N-2-(aminoethyl)-3-aminopropyltrimethoxysilane and chloropropyltrimethoxysilane (trade name; X-12-5263HP, manufactured by Shin-Etsu Chemical Co., Ltd.) disclosed in Japanese Patent Laid-Open No. 2012-197330, which is used as the compound (C) in Examples, which will be described later, is represented by the above formula (c2), R^{x20} and R^{x21} are both hydrogen atoms; p20 is 8 (provided that the number of repeating units replaced by the amine skeleton is excluded); p21 is 0; the number of amine skeletons is 2 (R¹⁰⁰ is a hydrogen atom in both cases); both ends are the same; p22 and p23 are each 3; and X²⁰ and X²¹ are each a methoxy group.

It is preferable that the organosilicon compound (C2) be a compound represented by the following formula (c2-2).

[Formula 8]

(R^{x25})₃₋ₚ₂₅(X²³)ₚ₂₅Si—C_{w}H_{2w}—Si(X²²)ₚ₂₄(R^{x24})₃ₚ₂₄ (c2-2)

In the above formula (c2-2),

X²² and X²³ are each independently a hydrolyzable group, and when there is a plurality of X²² and X²³, the plurality of X²² and X²³ is optionally different from each other;

R^{x24} and R^{x25} are each independently an alkyl group having 1 to 20 carbon atoms, and when there is a plurality of R^{x24} and R^{x25}, the plurality of R^{x24} and R^{x25} is optionally different from each other;

as for —C_{w}H_{2w}—, at least one of methylene groups, which are part thereof, is replaced by an amine skeleton —NR¹⁰⁰—, where R¹⁰⁰ is a hydrogen atom or an alkyl group;

w is an integer of 1 to 30 (provided that the number of methylene groups replaced by the amine skeleton is excluded); and p24 and p25 are each independently an integer of 1 to 3.

It is preferable that X²² and X²³ be each an alkoxy group, a halogen atom, a cyano group, or an isocyanate group, it is more preferable that they be each an alkoxy group, it is still more preferable that they be each an alkoxy group having 1 to 4 carbon atoms, it is even more preferable that they be each a methoxy group or an ethoxy group, and it is particularly preferable that they be each a methoxy group.

The amine skeleton —NR¹⁰⁰— may be present in plurality, in which case it is preferable that the number of amine skeletons be 1 to 10, it is more preferable that it be 1 to 5, and it is still more preferable that it be 2 to 5. Also, in this case, it is preferable that the compound have an alkylene group between adjacent amine skeletons. It is preferable that the number of carbon atoms in the alkylene group be 1 to 10, and it is more preferable that it be 1 to 5. The number of carbon atoms in the alkylene group between adjacent amine skeletons is included in the total number of w.

When R¹⁰⁰ in the amine skeleton —NR¹⁰⁰— is an alkyl group, it is preferable that the number of carbon atoms be 5 or less and it is more preferable that it be 3 or less. It is preferable that the amine skeleton —NR¹⁰⁰— be —NH— (R¹⁰⁰ be a hydrogen atom).

It is preferable that R^{x24} and R^{x25} be each an alkyl group having 1 to 10 carbon atoms, and it is more preferable that they be each an alkyl group having 1 to 5 carbon atoms.

It is preferable that p24 and p25 be each an integer of 2 to 3, and it is more preferable that they be each 3.

It is preferable that w be 1 or more, it is more preferable that it be 2 or more, and it is also preferable that it be 20 or less, and it is more preferable that it be 10 or less.

1-2-3. Organosilicon Compound (C) Represented by the Formula (c3) (Hereinafter, Organosilicon Compound (C3))

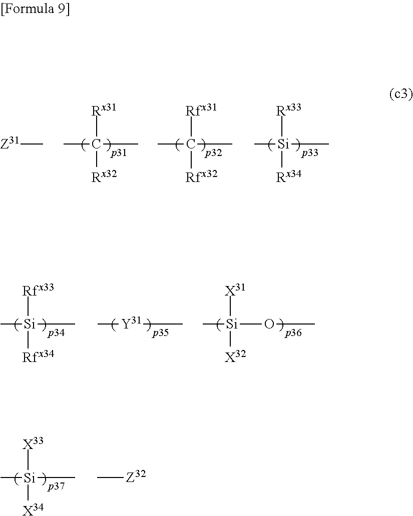

In the above formula (c3),

Z³¹ and Z³² are each independently a reactive functional group other than hydrolyzable and hydroxy groups. Examples of the reactive functional group include a vinyl group, an α-methylvinyl group, a styryl group, a methacryloyl group, an acryloyl group, an amino group, an epoxy group, a ureido group, or a mercapto group. As Z³¹ and Z³², an amino group, a mercapto group, or a methacryloyl group is preferred, and an amino group is particularly preferred.

R^{x31}, R^{x32}, R^{x33}, and R^{x34} are each independently a hydrogen atom or an alkyl group having 1 to 4 carbon atoms, and when there is a plurality of R^{x31}, the plurality of R^{x31} is optionally different from each other, when there is a plurality of R^{x32}, the plurality of R^{x32} is optionally different from each other, when there is a plurality of R^{x33}, the plurality of R^{x33} is optionally different from each other, and when there is a plurality of R^{x34}, the plurality of R^{x34} is optionally different from each other. It is preferable that R^{x31}, R^{x32}, R^{x33}, and R^{x34} be each a hydrogen atom or an alkyl group having 1 to 2 carbon atoms, and it is more preferable that they be each a hydrogen atom.

Rf^{x31}, Rf^{x32}, Rf^{x33}, and Rf^{x34} are each independently an alkyl group having 1 to 20 carbon atoms in which one or more hydrogen atoms are replaced by fluorine atoms, or a fluorine atom, and when there is a plurality of Rf^{x31}, the plurality of Rf^{x31} is optionally different from each other, when there is a plurality of Rf^{x32}, the plurality of Rf^{x32} is optionally different from each other, when there is a plurality of Rf^{x33}, the plurality of Rf^{x33} is optionally different from each other, and when there is a plurality of Rf^{x34}, the plurality of Rf^{x34} is optionally different from each other. It is preferable that Rf^{x31}, Rf^{x32}, Rf^{x33}, and Rf^{x34} be each an alkyl group having 1 to carbon atoms in which one or more hydrogen atoms are replaced by fluorine atoms, or a fluorine atom.

Y³¹ is —NH—, —N(CH₃)—, or —O—, and when there is a plurality of Y³¹, the plurality of Y³¹ is optionally different from each other. It is preferable that Y³¹ be —NH—.

X³¹, X³², X³³, and X³⁴ are each independently —OR^{c}, where R^{c} is a hydrogen atom, an alkyl group having 1 to 4 carbon atoms, or an amino-C₁₋₃ alkyl-di-C₁₋₃ alkoxysilyl group, and when there is a plurality of X³¹, the plurality of X³¹ is optionally different from each other, when there is a plurality of X³², the plurality of X³² is optionally different from each other, when there is a plurality of X³³, the plurality of X³³ is optionally different from each other, and when there is a plurality of X³⁴, the plurality of X³⁴ is optionally different from each other. It is preferable that X³¹, X³², X³³, and X³⁴ be —OR^{c}, where R^{c} is a hydrogen atom or an alkyl group having 1 to 2 carbon atoms, and it is more preferable that RC be a hydrogen atom.

p31 is an integer of 0 to 20, p32, p33, and p34 are each independently an integer of 0 to 10, p35 is an integer of 0 to 5, p36 is an integer of 1 to 10, and p37 is 0 or 1. p31 is preferably 1 to 15, more preferably 3 to 13, and still more preferably 5 to 10. Preferably, p32, p33, and p34 are each independently 0 to 5, and more preferably, they are all 0 to 2. p35 is preferably 0 to 3. p36 is preferably 1 to 5, and more preferably 1 to 3. p37 is preferably 1.

The organosilicon compound (C3) is constituted such that p31 —{C(R^{x31})(R^{x32})}— units (U_{c31}), p32 —{C(Rf^{x31})(Rf^{x32})}— units (U_{c32}), p33 —{Si(R^{x33})(R^{x34})}— units (U_{c33}), p34 —{Si(Rf^{x33})(Rf^{x34})}— units (U_{c34}), p35-Y³¹-units (U_{c35}), p36 —{Si(X³¹)(X³²)—O}— units (U_{c36}), and p37 —{Si(X³³)(X³⁴)}— units (U_{c37}) are each arranged and bonded in any order when the condition is satisfied that at least one of Z³¹ and Z³² is an amino group or at least one Y³¹ is —NH— or —N(CH₃)—, and as long as one end of the compound represented by formula (c3) is Z³¹—, the other end is Z³²—, and —O— is not linked to —O—. As for p31 —{C(R^{x31})(R^{x32})}— units (U_{c31}), —{C(R^{x31})(R^{x32})} are not necessarily consecutively bonded, and they may be bonded via other units in the middle, as long as there are p31 units in total. The same applies to units bracketed by p32 to p37, respectively.

As the organosilicon compound (C3), a compound is preferred in which Z³¹ and Z³² are each an amino group; R^{x31} and R^{x32} are each a hydrogen atom; p31 is 3 to 13 (preferably 5 to 10); R^{x33} and R^{x34} are both hydrogen atoms; Rf^{x31} to Rf^{x34} are all alkyl groups having 1 to 10 carbon atoms in which one or more hydrogen atoms are replaced by fluorine atoms, or fluorine atoms; p32 to p34 are all 0 to 5; Y³¹ is —NH—; p35 is 0 to 5 (preferably 0 to 3); X³¹ to X³⁴ are all —OH; p36 is 1 to 5 (preferably 1 to 3); and p37 is 1.

It is preferable that the organosilicon compound (C3) be represented by the following formula (c3-2).

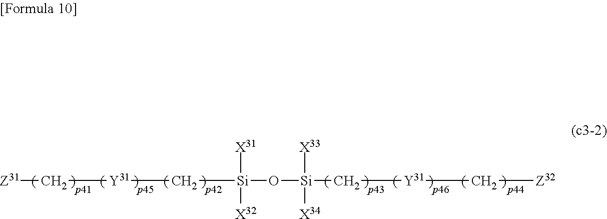

In the above formula (c3-2), Z³¹, Z³², X³¹, X³², X³³, X³⁴, and Y³¹ have the same meaning as those in formula (c3), p41 to p44 are each independently an integer of 1 to 6, and p45 and p46 are each independently 0 or 1.

In formula (c3-2), as Z³¹ and Z³², an amino group, a mercapto group, or a methacryloyl group is preferred, and an amino group is particularly preferred. It is preferable that X³¹, X³², X³³, and X³⁴ be —OR^{c}, where R^{c} is a hydrogen atom or an alkyl group having 1 to 2 carbon atoms, and it is more preferable that RC be a hydrogen atom. It is preferable that Y³¹ be —NH—. p41 to p44 are each preferably 1 or more, and also preferably 5 or less, and more preferably 4 or less. It is preferable that p45 and p46 be both 0.

As described above, the mixed composition also contains one in which the reaction has progressed after mixing the organosilicon compound (A), the organosilicon compound (C), and the fluorinated solvent (D1) and/or the non-fluorinated solvent (D2), and examples of the reaction that has progressed include a case in which the mixed composition contains a compound in which a hydrolyzable group bonded to a silicon atom of the organosilicon compound (C) has become a —SiOH group due to hydrolysis. Other examples of the reaction that has progressed also include a case in which the mixed composition contains a condensation product of the organosilicon compound (C). Examples of the condensation product include a condensation product formed by dehydration condensation of a —SiOH group that the organosilicon compound (C) has or a —SiOH group of the organosilicon compound (C) generated by hydrolysis with a —SiOH group derived from the organosilicon compound (C), or with a —SiOH group derived from another compound. More specifically, examples of the condensation product of the organosilicon compound (C) include an organosilicon compound (C3′) in which the organosilicon compounds (C3) are condensed and bonded via at least any of the above X³¹ to X³⁴.

The organosilicon compound (C3′) is a compound having two or more structures (c31-1) represented by the following formula (c31-1) and the structures (c31-1) are bonded to each other in a chain or ring form via *3 or *4 below, wherein the bond via *3 or *4 below is due to condensation via X³¹ or X³² of the two or more organosilicon compounds (C3);

to each of *1 and *2 of the following formula (c31-1) is bonded a group in which at least one of the units bracketed by p31, p32, p33, p34, p35, (p36)-1, and p37 of the following formula (c31-2) is bonded in any order and the end is Z—, and for each of the plurality of structures (c31-1), the groups bonded to *1 and *2 may be different; and

when the plurality of structures (c31-1) is bonded in a chain form, the *3 end is a hydrogen atom and the *4 end is a hydroxy group.

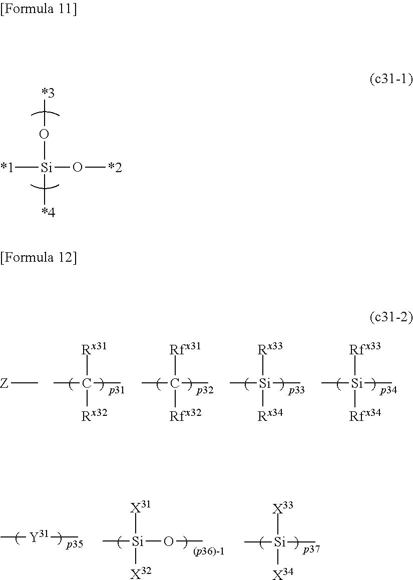

In the above formula (c31-2),

Z is a reactive functional group other than hydrolyzable and hydroxy groups; and

R^{x31}, R^{x32}, R^{x33}, R^{x34}, Rf^{x31}, Rf^{x32}, Rf^{x33}, Rf^{x34}, Y³¹, X³¹, X³², X³³, X³⁴, and p31 to p37 have the same meaning as these signs in the above formula (c3).

In the case where the organosilicon compound (C3) is a compound represented by the above formula (c3-2), examples of the organosilicon compound (C3′) include a compound in which structures represented by the following formula (c31-3) are bonded to each other in a chain or ring form via *3 or *4 below. In the case where the structures represented by the following formula (c31-3) are bonded in a chain form, the *3 end is a hydrogen atom and the *4 end is a hydroxy group.

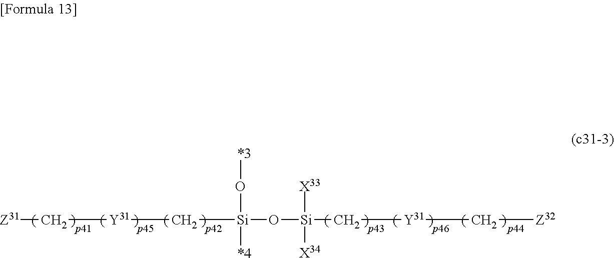

The signs in the above formula (c31-3) all have the same meaning as the signs in the above formula (c3-2).

It is preferable that the organosilicon compound (C3′) be a compound in which 2 to 10 (preferably 3 to 8) structures represented by the above formula (c31-3) are bonded.

As the organosilicon compound (C), only one type may be used, or two or more types may be used. As the organosilicon compound (C), it is preferable to use at least the organosilicon compound (C1) and/or the organosilicon compound (C2).

The amount (mass ratio) of the organosilicon compound (C) is preferably 0.005% by mass or more, more preferably 0.01% by mass or more, still more preferably by mass or more, and further preferably 0.03% by mass or more in 100% by mass of the mixed composition. Also, the upper limit of the amount (mass ratio) of the organosilicon compound (C) is 1% by mass or less, 0.5% by mass or less, 0.3% by mass or less, 0.1% by mass or less, and 0.07% by mass or less in 100% by mass of the mixed composition, in the order of preference.

In addition, the mass ratio of the organosilicon compound (C) to the organosilicon compound (A) is preferably 15% by mass or more, more preferably 20% by mass or more, still more preferably 50% by mass or more, further preferably 80% by mass or more, and particularly preferably 100% by mass or more, and it is also preferably 200% by mass or less, and more preferably 150% by mass or less.

1-3. Fluorinated Solvent (D1)

The organosilicon compound (A) is particularly easy to be dissolved in fluorinated solvents. As the fluorinated solvent (D1), for example, a fluorinated ether solvent, a fluorinated amine solvent, a fluorinated hydrocarbon solvent, a fluorinated alcohol solvent, and other solvents can be used, and in particular, it is preferable to use a fluorinated solvent with a boiling point of 100° C. or higher.

Examples of the fluorinated ether solvent may include a hydrofluoroether having 3 to 8 carbon atoms, and for example, C₃F₇OCH₃ (manufactured by 3M Company, Novec (R) 7000), C₄F₉OCH₃ (manufactured by 3M Company, Novec (R) 7100), C₄F₉OC₂H₅ (manufactured by 3M Company, Novec (R) 7200), C₂F₅CF(OCH₃)C₃F₇ (manufactured by 3M Company, Novec (R) 7300), and others can be used.

As the fluorinated amine solvent, preferred is an amine formed by replacing at least one hydrogen atom of ammonia by a fluoroalkyl group, and preferred is a tertiary amine formed by replacing all hydrogen atoms of ammonia by fluoroalkyl groups (in particular, perfluoroalkyl groups). Specifically, examples thereof include tris(heptafluoropropyl)amine, and Fluorinert (R) FC-3283 (manufactured by 3M Company) corresponds to this.

Examples of the fluorinated hydrocarbon solvent include a fluorinated aliphatic hydrocarbon solvent such as 1,1,1,3,3-pentafluorobutane and perfluorohexane, and a fluorinated aromatic hydrocarbon solvent such as 1,3-bis(trifluoromethylbenzene). Examples of the 1,1,1,3,3-pentafluorobutane include Solve 55 (Solvex Inc.).

Examples of the fluorinated alcohol solvent include 1,1,1,3,3,3-hexafluoro-2-propanol, 2,2,3,3-tetrafluoro-1-propanol, 2,2,3,3,4,4,5,5-octafluoro-1-pentanol, 2,2,3,3,4,4,5,5,6,6,7,7-dodecafluoro-1-heptanol, perfluorooctylethanol, and 1H, 1H, 2H, 2H-tridecafluoro-1-n-octanol.

As the fluorinated solvent, in addition to the above, a hydrochlorofluorocarbon such as Asahiklin (R) AK225 (manufactured by AGC Inc.), a hydrofluorocarbon such as Asahiklin (R) AC2000 (manufactured by AGC Inc.), and others can be used.

As the fluorinated solvent (D1), only one type may be used, or two or more types may be used. It is preferable to use at least the fluorinated ether solvent as the fluorinated solvent (D1), and it is more preferable that the fluorinated ether solvent be a hydrofluoroether having 4 to 6 carbon atoms.

The amount of the fluorinated solvent (D1) is preferably 50% by mass or more, more preferably 60% by mass or more, and still more preferably 70% by mass or more, and the amount of the fluorinated solvent (D1) may be 99% by mass or less, or may be 95% by mass or less, for example, in 100% by mass of the mixed composition. In the case where a plurality of types is used as the fluorinated solvent (D1), it is only necessary for the total amount to be in the aforementioned range.

1-4. Non-Fluorinated Solvent (D2)

Since the organosilicon compound (C) is easy to be dissolved in the non-fluorinated solvent (D2), it is thought to be possible to suppress the organosilicon compounds (C) from gathering together and being condensed.

As the non-fluorinated solvent, that is, the solvent (D2) that does not contain F atoms, water, an alcohol solvent, a ketone solvent, an ether solvent, a hydrocarbon solvent, an ester solvent, and other solvents can be used.

Examples of the alcohol solvent include methanol, ethanol, 1-propanol, 2-propanol (isopropyl alcohol), and 1-butanol.

Examples of the ketone solvent include acetone, methyl ethyl ketone, and methyl isobutyl ketone.

Examples of the ether solvent include diethyl ether, dipropyl ether, tetrahydrofuran, and 1,4-dioxane.

Examples of the hydrocarbon solvent include an aliphatic hydrocarbon solvent such as pentane and hexane, an alicyclic hydrocarbon solvent such as cyclohexane, and an aromatic hydrocarbon solvent such as benzene, toluene, and xylene.

Examples of the ester solvent include ethyl acetate, propyl acetate, butyl acetate, amyl acetate, and isoamyl acetate.

As the non-fluorinated solvent (D2), only one type may be used, or two or more types may be used. It is preferable that the non-fluorinated solvent (D2) contain at least one of the alcohol solvent, the ketone solvent, and the ester solvent, it is more preferable that it contain the alcohol solvent, and it is also preferable that it contain the ester solvent and/or the ketone solvent together with the alcohol solvent. When the non-fluorinated solvent (D2) contains the alcohol solvent, condensation of the organosilicon compounds (C) is easily suppressed. Also, when the non-fluorinated solvent (D2) contains the alcohol solvent and the ester solvent, it is possible to obtain the effect that a uniform film with good appearance is obtained or the wear resistance of the resulting film is improved. In addition, when the non-fluorinated solvent (D2) contains the alcohol solvent and the ketone solvent, the wear resistance of the resulting film is improved. Furthermore, when the non-fluorinated solvent (D2) contains the alcohol solvent, the ester solvent, and the ketone solvent, a uniform film with good appearance is obtained.

When the non-fluorinated solvent (D2) contains the alcohol solvent, the amount (mass ratio) of the alcohol solvent is preferably 50% by mass or more, more preferably 60% by mass or more, and still more preferably 75% by mass or more, and it may be 100% by mass or may be 90% by mass or less, in 100% by mass of the non-fluorinated solvent (D2).

When the non-fluorinated solvent (D2) contains the ester solvent, the amount (mass ratio) of the ester solvent is preferably 3% by mass or more, more preferably 5% by mass or more, and still more preferably 8% by mass or more, and it may be 15% by mass or less or may be 13% by mass or less, in 100% by mass of the non-fluorinated solvent (D2).

When the non-fluorinated solvent (D2) contains the ketone solvent, the amount (mass ratio) of the ketone solvent is preferably 3% by mass or more, more preferably 5% by mass or more, and still more preferably 8% by mass or more, and it may be 15% by mass or less or may be 13% by mass or less, in 100% by mass of the non-fluorinated solvent (D2).

The amount of the non-fluorinated solvent (D2) is preferably 5% by mass or more, more preferably 10% by mass or more, and still more preferably 13% by mass or more, and the upper limit may be 30% by mass or may be 25% by mass, for example, in 100% by mass of the mixed composition. In the case where a plurality of types is used as the non-fluorinated solvent (D2), it is only necessary for the total amount to be in the aforementioned range.

As mentioned above, it is preferable that, in the above mixed composition, at least one of the fluorinated solvent (D1) and the non-fluorinated solvent (D2) be mixed in, and it is more preferable that both the fluorinated solvent (D1) and the non-fluorinated solvent (D2) be mixed in.

It is preferable that the distance Ra of the Hansen solubility parameters (Hansen solubility parameters, HSP; hereinafter, they may be abbreviated as “HSP”) of the fluorinated solvent (D1) and the non-fluorinated solvent (D2), as determined according to the following expression (E.1), be at or above a predetermined value.

The Hansen solubility parameters are expressed in a three dimensional space by dividing the solubility parameter introduced by Hildebrand into three components: dispersion term (δD), polarity term (δP), and hydrogen bond term (OH). The dispersion term (OD) indicates the effect by dispersion force, the polarity term (δP) indicates the effect by dipole-to-dipole force, and the hydrogen bond term (δH) indicates the effect by hydrogen bond force.

Note that the definition and calculation of the Hansen solubility parameters are described in Hansen Solubility Parameters: A Users Handbook authored by Charles M. Hansen (CRC Press, 2007). In addition, by using the computer software Hansen Solubility Parameters in Practice (HSPiP), the Hansen solubility parameters can also be conveniently estimated from the chemical structure of compounds for which literature values are not known. Furthermore, as for compounds for which literature values are not known, the Hansen solubility parameters can also be calculated by using the solubility sphere method, which will be described later. In the present invention, when determining the Hansen solubility parameters of the fluorinated solvent (D1) and the non-fluorinated solvent (D2), the values of registered Hansen solubility parameters are used for solvents registered in the database using the HSPiP version 5.2.05, and the Hansen solubility parameters for solvents not registered are calculated by using the solubility sphere method, which will be described below.

The solubility sphere method is a method of calculating the Hansen solubility parameters of an object, in which the Hansen solubility parameters are determined by a solubility test in which the object is dissolved or dispersed in a number of different solvents for which the Hansen solubility parameters are established to evaluate the solubility or dispersibility of the object in a particular solvent. It is preferable to select the types of solvents used in the solubility test such that the total value of the dispersion term, polarity term, and hydrogen bond term of the HSP of each solvent varies widely among the solvents, and more specifically, it is preferable to perform the evaluation using preferably 10 or more types, more preferably 15 or more types, and still more preferably 17 or more types of solvents. Specifically, among the solvents used in the above solubility test, a sphere with the smallest radius (solubility sphere) is found, in which all the three dimensional points of solvents that dissolve or disperse the object are inside the sphere and the points of solvents that do not dissolve the object are outside the sphere, and the center coordinates of the sphere are used as the Hansen solubility parameters of the object. The evaluation of solubility and dispersibility is carried out by visually judging whether the target object is dissolved or not and dispersed or not in the solvent, respectively. In the case where a mixture of the object and the solvent becomes clouded, the object is precipitated, or the object and the solvent are separated in layers, it is sufficient to consider that the target object is not dissolved or not dispersed in the solvent. The specific method of the solubility test is described in detail in the Examples section.

For example, in the case where the Hansen solubility parameters of another solvent not used for measuring the Hansen solubility parameters of the object are (δd,δp,δh), the solvent is considered to dissolve or disperse the object if the point indicated by its coordinates is enclosed inside the solubility sphere of the object. On the other hand, if its coordinate point is outside the solubility sphere of the object, that solvent is considered incapable of dissolving and dispersing the object.

The Hansen solubility parameter distance Ra1 between the fluorinated solvent (D1) and the non-fluorinated solvent (D2) as determined according to the following expression (E.11) is preferably 5.2 (J/cm³)^{0.5} or more, more preferably 5.5 (J/cm³)^{0.5} or more, still more preferably 6.5 (J/cm³)^{0.5} or more, and further preferably 7 (J/cm³)^{0.5} or more, and the distance Ra1 is also 25 (J/cm³)^{0.5} or less, for example.

[Expression 1]

Ra1=\sqrt{4(δD1−δD2)²+(δP1−δP2)²+(δH1−δH2)²} (E.11)

[In the expression,

δD1 is a dispersion term (J/cm³)^{0.5} in Hansen solubility parameters of the fluorinated solvent (D1);

δD2 is a dispersion term (J/cm³)^{0.5} in Hansen solubility parameters of the non-fluorinated solvent (D2);

δP1 is a polarity term (J/cm³)^{0.5} in Hansen solubility parameters of the fluorinated solvent (D1);

δP2 is a polarity term (J/cm³)^{0.5} in Hansen solubility parameters of the non-fluorinated solvent (D2);

δH1 is a hydrogen bond term (J/cm³)^{0.5} in Hansen solubility parameters of the fluorinated solvent (D1); and

δH2 is a hydrogen bond term (J/cm³)^{0.5} in Hansen solubility parameters of the non-fluorinated solvent (D2)]

In the present invention, in the case of using a plurality of types as the fluorinated solvent (D1) or in the case of using a plurality of types as the non-fluorinated solvent (D2), it is only necessary for the aforementioned Hansen solubility parameter distance Ra to satisfy the aforementioned range in any combination of one type each selected from the fluorinated solvent (D1) and the non-fluorinated solvent (D2).

Also, in the case of using a plurality of types as the fluorinated solvent (D1), from the δD1, the δP1, and the δH1 of each fluorinated solvent and the volume fraction of each fluorinated solvent relative to all fluorinated solvents, the δD1total, the δP1total, and the δH1total of the entire fluorinated solvents can be determined. The δD1total can be determined based on the following expression (E.D1), and the δP1total and the δH1total can also be determined in the same manner based on expressions (E.P1) and (E.H1) below, respectively.

$$\begin{matrix}[ Expression 2 ] & \\ δ D 1 total = {\sum }_{i = 1}^{n} δ D {1}_{i} \times Xi & ( E . D 1 )\end{matrix}$$

In the above expression, δD1ᵢ is the value of δD1 of each fluorinated solvent in the case where there is a plurality of types of fluorinated solvents (D1), n is the number of types of fluorinated solvents (D1), and Xᵢ is the volume fraction of each fluorinated solvent relative to all fluorinated solvents. Note that the volume fraction is a proportion in the case where the volume of all fluorinated solvents is set to 1, and the same applies to the following expressions (E.P1) and (E.H1).

$$\begin{matrix}[ Expression 3 ] & \\ δ P 1 total = {\sum }_{i = 1}^{n} δ P {1}_{i} \times Xi & ( E . P1 )\end{matrix}$$

In the expression, δP1ᵢ is the value of δP1 of each fluorinated solvent in the plurality of types of fluorinated solvents (D1), n is the number of types of fluorinated solvents (D1), and Xᵢ is the volume fraction of each fluorinated solvent relative to all fluorinated solvents.

$$\begin{matrix}[ Expression 4 ] & \\ δ H 1 total = {\sum }_{i = 1}^{n} δ H {1}_{i} \times Xi & ( E . H1 )\end{matrix}$$

In the expression, δH1ᵢ is the value of δH1 of each fluorinated solvent in the plurality of types of fluorinated solvents (D1), n is the number of types of fluorinated solvents (D1), and Xᵢ is the volume fraction of each fluorinated solvent relative to all fluorinated solvents.

In addition, in the case of using a plurality of types as the non-fluorinated solvent (D2), the δD2total of the entire non-fluorinated solvents can be determined according to expression (E.D2), in which D1 in the above expression (E.D1) is all replaced by D2 and the fluorinated solvent is replaced by the non-fluorinated solvent, the δP2total can be determined according to expression (E.P2), in which P1 in the above expression (E.P1) is all replaced by P2 and the fluorinated solvent is replaced by the non-fluorinated solvent, and furthermore, the δH2total can be determined according to expression (E.H2), in which H1 in the above expression (E.H1) is all replaced by H2 and the fluorinated solvent is replaced by the non-fluorinated solvent. Then, from the δD1total, the δP1total, and the δH1total, and the δD2total, the δP2total, and the δH2total, the distance Ra1′ between the HSP of the entire fluorinated solvents and the HSP of the entire non-fluorinated solvents can be determined according to expression (E.12) below. The distance Ra1′ is preferably 11 (J/cm³)^{0.5} or more, more preferably 12.0 (J/cm³)^{0.5} or more, and still more preferably 13.0 (J/cm³)^{0.5} or more, and it is also preferably 17.0 (J/cm³)^{0.5} or less, more preferably 16.0 (J/cm³)^{0.5} or less, and still more preferably 15 (J/cm³)^{0.5} or less. Note that, for the δD1total, the δP1total, and the δH1total, and the δD2total, the δP2total, and the δH2total, in the case where there is only one type of fluorinated solvent (D1) or non-fluorinated solvent (D2), it is sufficient to use the value of the one type of fluorinated solvent (D1) or non-fluorinated solvent (D2).

$$\begin{matrix}[ Expression 5 ] & \\ Ra {1}^{′} = \sqrt{\begin{matrix}4 {( δ D 1 total - δ D 2 total )}^{2} + {( δ P 1 total - δ P 2 total )}^{2} + \\ {( δ H 1 total - δ H 2 total )}^{2}\end{matrix}} & ( E . 12 )\end{matrix}$$

In addition, the Hansen solubility parameter distance Ra2 between the organosilicon compound (C) and the non-fluorinated solvent (D2) as determined according to the following expression (E.3) is preferably 0.5 (J/cm³)^{0.5} or more, more preferably 1.0 (J/cm³)^{0.5} or more, still more preferably 2.0 (J/cm³)^{0.5} or more, further preferably 2.5 (J/cm³)^{0.5} or more, and particularly preferably 3.0 (J/cm³)^{0.5} or more, 4.0 (J/cm³)^{0.5} or more, or 5.0 (J/cm³)^{0.5} or more, and it is also 10 (J/cm³)^{0.5} or less, for example, preferably 9 (J/cm³)^{0.5} or less, and more preferably 8 (J/cm³)^{0.5} or less.

$$\begin{matrix}[ Expression 6 ] & \\ Ra 2 = \sqrt{\begin{matrix}4 {( δ D C total - δ D 2 total )}^{2} + {( δ P C total - δ P 2 total )}^{2} + \\ {( δ H C total - δ H 2 total )}^{2}\end{matrix}} & ( E . 3 )\end{matrix}$$

[In the expression,

δDCtotal is a dispersion term (J/cm³)^{0.5} in Hansen solubility parameters of one type of organosilicon compound (C) in the case where there is only one type of organosilicon compound (C), and is a value determined according to expression (E.4D) below in the case where there is a plurality of types of organosilicon compounds (C);

δD2total is a dispersion term (J/cm³)^{0.5} in Hansen solubility parameters of one type of non-fluorinated solvent (D2) in the case where there is only one type of non-fluorinated solvent (D2), and is a value determined according to the above expression (E.D2) in the case where there is a plurality of types of non-fluorinated solvents (D2);

δPCtotal is a polarity term (J/cm³)^{0.5} in Hansen solubility parameters of one type of organosilicon compound (C) in the case where there is only one type of organosilicon compound (C), and is a value determined according to expression (E.4P) below in the case where there is a plurality of types of organosilicon compounds (C);

δP2total is a polarity term (J/cm³)^{0.5} in Hansen solubility parameters of one type of non-fluorinated solvent (D2) in the case where there is only one type of non-fluorinated solvent (D2), and is a value determined according to the above expression (E.P2) in the case where there is a plurality of types of non-fluorinated solvents (D2);

δHCtotal is a hydrogen bond term (J/cm³)^{0.5} in Hansen solubility parameters of one type of organosilicon compound (C) in the case where there is only one type of organosilicon compound (C), and is a value determined according to expression (E.4H) below in the case where there is a plurality of types of organosilicon compounds (C); and

δH2total is a hydrogen bond term (J/cm³)^{0.5} in Hansen solubility parameters of one type of non-fluorinated solvent (D2) in the case where there is only one type of non-fluorinated solvent (D2), and is a value determined according to the above expression (E.H2) in the case where there is a plurality of types of non-fluorinated solvents (D2)]

The Hansen solubility parameters of the organosilicon compound (C) can be determined by the same approach as the method for determining the Hansen solubility parameters of the fluorinated solvent (D1) and the non-fluorinated solvent (D2) as described above; however, in the present invention, the Hansen solubility parameters of the organosilicon compound (C) are calculated by using the above-mentioned solubility sphere method.

Note that, in the case where a single compound is used as the organosilicon compound (C), the HSP values (δDC,δPC,δHC) of the organosilicon compound (C) calculated by the solubility sphere method are used as they are as the values of δDCtotal, δPCtotal, and δHCtotal, while in the case where a plurality of types is used as the organosilicon compound (C), as shown in the following expressions (E.4D), (E.4P), and (E.4H), the δDCtotal, the δPCtotal, and the δHCtotal of the entire organosilicon compounds (C), calculated from the HSP values (δDC,δPC,δHC) of each organosilicon compound (C) and the volume fraction of each organosilicon compound (C) relative to all organosilicon compounds (C), are used.

$$\begin{matrix}[ Expression 7 ] & \\ δ D C total = {\sum }_{i = 1}^{n} δ D {C}_{i} \times XCi & ( E . 4 D )\end{matrix}$$

In the above expression, δDCᵢ is the value of the dispersion term (δD) of each organosilicon compound (C) in the case where there is a plurality of types of organosilicon compounds (C), n is the number of types of organosilicon compounds (C), and XCᵢ is the volume fraction of each organosilicon compound (C) relative to all organosilicon compounds (C). Note that the volume fraction is a proportion in the case where the volume of all organosilicon compounds (C) is set to 1, and the same applies to the following expressions (E.4P) and (E.4H).

$$\begin{matrix}[ Expression 8 ] & \\ δ P C total = {\sum }_{i = 1}^{n} δ P {C}_{i} \times XCi & ( E . 4 P )\end{matrix}$$

In the above expression, δPCᵢ is the value of the polarity term (δP) of each organosilicon compound (C) in the case where there is a plurality of types of organosilicon compounds (C), n is the number of types of organosilicon compounds (C), and XCi is the volume fraction of each organosilicon compound (C) relative to all organosilicon compounds (C).

$$\begin{matrix}[ Expression 9 ] & \\ δ H C total = {\sum }_{i = 1}^{n} δ H {C}_{i} \times XCi & ( E . 4 H )\end{matrix}$$

In the above expression, δHCᵢ is the value of the hydrogen bond term (δH) of each organosilicon compound (C) in the case where there is a plurality of types of organosilicon compounds (C), n is the number of types of organosilicon compounds (C), and XCi is the volume fraction of each organosilicon compound (C) relative to all organosilicon compounds (C).

In the case where a plurality of types is used as the non-fluorinated solvent (D2), it is sufficient to use the δD2total, the δP2total, and the δH2total determined from the above expressions (E.D2), (E.P2), and (E.H2) in expression (E.3), and in the case where there is only one type of non-fluorinated solvent (D2), it is sufficient to use the values of δD2, δP2, and δH2 of the one type of non-fluorinated solvent (D2) as the values of δD2total, δP2total, and δH2total.

The mass ratio of the fluorinated solvent (D1) to the non-fluorinated solvent (D2) is preferably 1% by mass or more, more preferably 50% by mass or more, still more preferably 100% by mass or more, and it is also preferably 200% by mass or more, 240% by mass or more, 280% by mass or more, or 300% by mass or more. Also, the mass ratio of the fluorinated solvent (D1) to the non-fluorinated solvent (D2) may be, for example, 3000% by mass or less, 2000% by mass or less, 1000% by mass or less, or 500% by mass or less. The mass ratio of the fluorinated solvent (D1) to the non-fluorinated solvent (D2) is preferably 200% by mass or more and 900% by mass or less, more preferably 240% by mass or more and 800% by mass or less, still more preferably 280% by mass or more and 700% by mass or less, or even more preferably 300% by mass or more and 600% by mass or less. If the value of the mass ratio of the fluorinated solvent (D1) to the non-fluorinated solvent (D2) is too small, wear resistance may decrease, while if it is too large, the appearance may be impaired.

1-5. Organosilicon Compound (B)

In the mixed composition, an organosilicon compound (B) represented by the following formula (b1) may be further mixed in. In the case where the organosilicon compound (B) is mixed in the mixed composition, the mixed composition is obtained by mixing the organosilicon compound (A), the organosilicon compound (B), the organosilicon compound (C), and the fluorinated solvent (D1) and/or the non-fluorinated solvent (D2), and also includes one in which the reaction has progressed after mixing them, for example, during storage. The organosilicon compound (B) has the action of improving the slideability of water droplets and others by being present between the organosilicon compounds (A) in the cured film. The organosilicon compound (B) has a hydrolyzable group or a hydroxy group represented by A², as will be described below. Examples of the hydrolyzable group include an alkoxy group, a halogen atom, a cyano group, an acetoxy group, and an isocyanate group.

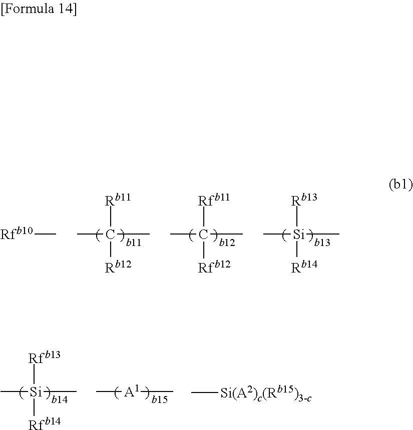

In the above formula (b1),

Rf^{b10} is an alkyl group having 1 to 20 carbon atoms in which one or more hydrogen atoms are replaced by fluorine atoms, or a fluorine atom;

R^{b11}, R^{b12}, R^{b13}, and R^{b14} are each independently a hydrogen atom or an alkyl group having 1 to 4 carbon atoms, and when there is a plurality of R^{b11}, the plurality of R^{b11} is optionally different from each other, when there is a plurality of R^{b12}, the plurality of R^{b12} is optionally different from each other, when there is a plurality of R^{b13}, the plurality of R^{b13} is optionally different from each other, and when there is a plurality of R^{b14}, the plurality of R^{b14} is optionally different from each other;

Rf^{b11}, Rf^{b12}, Rf^{b13}, and Rf^{b14} are each independently an alkyl group having 1 to 20 carbon atoms in which one or more hydrogen atoms are replaced by fluorine atoms, or a fluorine atom, and when there is a plurality of Rf^{b11}, the plurality of Rf^{b11} is optionally different from each other, when there is a plurality of Rf^{b12}, the plurality of Rf^{b12} is optionally different from each other, when there is a plurality of Rf^{b13}, the plurality of Rf^{b13} is optionally different from each other, and when there is a plurality of Rf^{b14}, the plurality of Rf^{b14} is optionally different from each other;

R^{b15} is an alkyl group having 1 to 20 carbon atoms, and when there is a plurality of R^{b15}, the plurality of R^{b15} is optionally different from each other;

A¹ is —O—, —C(═O)—O—, —O—C(═O)—, —NR—, —NRC(═O)—, or —C(═O)NR—, where R is a hydrogen atom, an alkyl group having 1 to 4 carbon atoms, or a fluorine-containing alkyl group having 1 to 4 carbon atoms, and when there is a plurality of A¹, the plurality of A¹ is optionally different from each other;

A² is a hydrolyzable group or a hydroxy group, and when there is a plurality of A², the plurality of A² is optionally different from each other;

b11, b12, b13, b14, and b15 are each independently an integer of 0 to 100;

c is an integer of 1 to 3; and

as for Rf^{b10}—, —Si(A²)_{c}(R^{b15})^{3-c}, b11—{C(R^{b11})(R^{b12})}-units (U_{b1}), b12 —{C(Rf^{b11})(Rf^{b12})}— units (U_{b2}), b13 —{Si(R^{b13})(R^{b14})}— units (U_{b3}), b14 —{Si(Rf^{b13}) (Rf^{b14})}— units (U_{b4}), and b15 -A¹- units (U_{b5}), each unit is arranged and bonded in any order as long as Rf^{b10}— is one end in formula (b1), —Si(A²)_{c}(R^{b15})_{3-c} is the other end, a fluoropolyether structure is not formed, and —O— is not linked to —O— or —F.

Rf^{b10} is each independently preferably a fluorine atom or a perfluoroalkyl group having 1 to 10 carbon atoms (more preferably 1 to 5 carbon atoms).

R^{b11}, R^{b12}, R^{b13}, and R^{b14} are each preferably a hydrogen atom.

R^{b15} is preferably an alkyl group having 1 to 5 carbon atoms.

A¹ is preferably —O—, —C(═O)—O—, or —O—C(═O)—.

A² is preferably an alkoxy group having 1 to 4 carbon atoms, or a halogen atom, and more preferably a methoxy group, an ethoxy group, or a chlorine atom.

b11 is preferably 1 to 30, more preferably 1 to 25, still more preferably 1 to 10, particularly preferably 1 to 5, and most preferably 1 to 2.

b12 is preferably 0 to 15, and more preferably 0 to 10.

b13 is preferably 0 to 5, and more preferably 0 to 2.

b14 is preferably 0 to 4, and more preferably 0 to 2.

b15 is preferably 0 to 4, and more preferably 0 to 2.

c is preferably 2 to 3, and more preferably 3.

The total value of b11, b12, b13, b14, and b15 is preferably 2 or more, more preferably 3 or more, and still more preferably 5 or more, and it is also preferably 80 or less, more preferably 50 or less, and still more preferably 20 or less.

In particular, it is preferable that Rf^{b10} be a fluorine atom or a perfluoroalkyl group having 1 to 5 carbon atoms, R^{b11} and R^{b12} be both hydrogen atoms, and A² be a methoxy group or an ethoxy group, and that b11 be 1 to 5, b12 be 0 to 5, b13, b14, and b15 be all 0, and c be 3.

Specifically, examples of the compound represented by the above formula (b1) include CⱼF₂ⱼ₊₁—Si—(OCH₃)₃ and CⱼF₂ⱼ₊₁—Si—(OC₂H₅)₃ (j is an integer of 1 to 12), and among the above, in particular, C₄F₉—Si—(OC₂H₅)₃, C₆F₁₃—Si—(OC₂H₅)₃, C₇F₁₅—Si—(OC₂H₅)₃, and C₈F₁₇—Si—(OC₂H₅)₃ are preferred. Other examples thereof include CF₃CH₂O(CH₂)ₖSiCl₃, CF₃CH₂O(CH₂)ₖSi(OCH₃)₃, CF₃CH₂O(CH₂)ₖSi(OC₂H₅)₃, CF₃(CH₂)₂Si(CH₃)₂(CH₂)ₖSiCl₃, CF₃(CH₂)₂Si(CH₃)₂(CH₂)ₖSi(OCH₃)₃, CF₃(CH₂)₂Si(CH₃)₂(CH₂)ₖSi(OC₂H₅)₃, CF₃(CH₂)₆Si(CH₃)₂(CH₂)ₖSiCl₃, CF₃(CH₂)₆Si(CH₃)₂(CH₂)ₖSi(OCH₃)₃, CF₃(CH₂)₆Si(CH₃)₂(CH₂)ₖSi(OC₂H₅)₃, CF₃COO(CH₂)ₖSiCl₃, CF₃COO(CH₂)ₖS(OCH₃), and CF₃COO(CH₂)ₖSi(OC₂H₅)₃ (k is all to 20, preferably 8 to 15). Examples thereof may also include CF₃(CF₂)ₘ —(CH₂)ₙSiCl₃, CF₃ (CF₂)ₘ—(CH₂)ₙSi(OCH₃)₃, and CF₃(CF₂)ₘ—(CH₂)ₙSi(OC₂H₅)₃ (m is all 0 to 10, preferably 0 to 7, and n is all 1 to 5, preferably 2 to 4). Examples thereof may also include CF₃(CF₂)ₚ—(CH₂)_{q}—Si—(CH₂CH═CH₂)₃ (p is all 2 to 10, preferably 2 to 8, and q is all 1 to 5, preferably 2 to 4). Further examples thereof include CF₃(CF₂)ₚ—(CH₂)_{q}SiCH₃Cl₂, CF₃(CF₂)ₚ—(CH₂)_{q}SiCH₃(OCH₃)₂, and CF₃(CF₂)ₚ—(CH₂)_{q}SiCH₃(OC₂H₅)₂ (p is all 2 to 10, preferably 3 to 7, and q is all 1 to 5, preferably 2 to 4).

Among the compound represented by the above formula (b1), a compound represented by the following formula (b2) is preferred.

[Formula 15]

R⁶⁰—R⁶¹—Si(OR⁶²)₃ (b2)

In the above formula (b2), R⁶⁰ is a perfluoroalkyl group having 1 to 8 carbon atoms, R⁶¹ is an alkylene group having 1 to 5 carbon atoms, and R⁶² is an alkyl group having 1 to 3 carbon atoms.

As the organosilicon compound (B), only one type may be used, or two or more types may be used. The amount of the organosilicon compound (B) is, for example, by mass or more, preferably 0.03% by mass or more, and it is also preferably 0.3% by mass or less, and more preferably 0.2% by mass or less in 100% by mass of the mixed composition.

As mentioned above, the above mixed composition also contains one in which the reaction has progressed after mixing the organosilicon compound (A), the organosilicon compound (C), and the fluorinated solvent (D1) and/or the non-fluorinated solvent (D2), as well as the organosilicon compound (B), which is used if necessary, and examples of the reaction that has progressed include a case in which the mixed composition contains a compound in which a hydrolyzable group bonded to a silicon atom of the above organosilicon compound (B) has become a —SiOH group due to hydrolysis. Other examples thereof include a case in which the mixed composition contains a condensation product of the organosilicon compound (B), and examples of the condensation product include a condensation product formed by dehydration condensation of a —SiOH group that the organosilicon compound (B) has or a —SiOH group of the organosilicon compound (B) generated by hydrolysis with a —SiOH group derived from the organosilicon compound (B), or with a —SiOH group derived from another compound.

The total amount of the organosilicon compound (A), the organosilicon compound (C), and the organosilicon compound (B), which is used if necessary, is preferably by mass or more, more preferably 0.02% by mass or more, still further preferably 0.04% by mass or more, still more preferably 0.05% by mass or more, even more preferably 0.08% by mass or more, and particularly preferably 0.1% by mass or more in 100% by mass of the mixed composition. The upper limit may be 1% by mass, for example, or may be 0.5% by mass.

In the mixed composition, additives other than the organosilicon compound (A), the organosilicon compound (C), the fluorinated solvent (D1), the non-fluorinated solvent (D2), and the organosilicon compound (B), which is preferably used, may be mixed in to the extent that the effects of the present invention are not inhibited, and for example, a variety of additives may be mixed in, such as a silanol condensation catalyst, an antioxidant, a rust inhibitor, an ultraviolet absorber, a light stabilizer, a fungicide, an antibacterial agent, an antiviral agent, an anti-organism adhesion agent, a deodorant, a pigment, a flame retardant, and an antistatic agent. The amount of the additives is preferably 5% by mass or less, and more preferably 1% by mass or less, in 100% by mass of the mixed composition.

When preparing the mixed composition, the order of mixing each compound is not limited, but it is preferable to separately prepare a solution (r1) in which the organosilicon compound (A) and the fluorinated solvent (D1) are mixed, and a solution (p1) in which the organosilicon compound (C) and the non-fluorinated solvent (D2) are mixed, and then mix the solution (r1) and the solution (p1).

2. Cured Film

The cured film of the present invention has an F content and an O content on one side surface (W) that are at or above a certain level. As will be described later, it is preferable that the cured film form a laminated body together with the substrate, and it is preferable that the one side surface (W) of the cured film be preferably the outermost surface of the laminated body, that is, it is preferable that it be the cured film surface on the opposite side from the substrate. The F content and the O content being at or above a certain level means, in other words, that there is a large amount of organosilicon compound (A) including a fluoropolyether structure present on the surface (W). The F content and the O content can be determined by measuring the elements constituting the surface (W) and amounts thereof by X-ray photoelectron spectroscopy (XPS). The elements constituting the surface (W) as measured by XPS are typically B, C, N, O, F, Si, P, S, and Cl, and in particular C, N, O, F, and Si. The contents of B, C, N, F, Si, P, S, and Cl are calculated based on the B1s spectrum, the C1s spectrum, the N1s spectrum, the O1s spectrum, the F1s spectrum, the Si2p spectrum, the P2p spectrum, the S2p spectrum, and the Cl2p spectrum, respectively.

The F content is 60 atom % or more, preferably 65 atom % or more, and it may also be 95 atom % or less or may be 85 atom % or less, relative to the entire elements constituting the surface (W). The F content can be determined based on the F1s (bond energy: 680 to 698 eV) spectrum.

The O content is 17 atom % or more, preferably 20 atom % or more, and it may also be 35 atom % or less or may be 30 atom % or less, relative to the entire elements constituting the surface (W). The O content can be determined based on the O1s (bond energy: 525 to 545 eV) spectrum.

Also, when the elements constituting the surface (W) and amounts thereof are measured by PAR-XPS, oxygen atoms that are CF×O are preferably 10 atom % or more, more preferably 12 atom % or more, and still more preferably 15 atom % or more relative to all elements. They may also be atom % or less, or may be 25 atom % or less. The proportion of oxygen atoms that are CF×O being in the aforementioned range means that there is a large amount of organosilicon compound (A) including a fluoropolyether structure present on the surface (W). The oxygen atoms that are CF×O are determined based on the bond energy peak of the O1s spectrum: 524 to 544 eV in the PAR-XPS spectrum.

Furthermore, when the ratio percentage Q: A^{F}_{C-F}/A^{N}_{C-N}×100 (atom %) of the amount of F atoms as C—F (in terms of amount of substance): A^{F}_{C-F} to the amount of N atoms as C—N(in terms of amount of substance): A^{N}_{C-N} is determined at a depth of 0.5 nm and a depth of 1.5 nm from the surface (W), it is preferable that Q_{0.5nm} (atom %) at a depth of 0.5 nm be 1000 (atom %) or more larger than Q_{1.5nm} (atom %) at a depth of 1.5 nm (that is, it is preferable that the value of Q_{0.5nm} (atom %)−Q_{1.5nm} (atom %) be 1000 (atom %) or more). The value of Q_{0.5nm} (atom %)−Q_{1.5nm} (atom %) is preferably 1200 (atom %) or more, and more preferably 1500 (atom %) or more, and it may also be 6000 (atom %) or less, may be 5000 (atom %) or less, or may be 3000 (atom %) or less. Such a requirement can be measured by PAR-XPS, and A^{F}_{C-F} can be calculated based on the F1s spectrum and A^{N}_{C-N} can be calculated based on the N1s spectrum.

As long as the value of Q_{0.5nm} (atom %)−Q_{1.5nm} (atom %) is in the aforementioned range, the respective values of Q_{0.5nm} (atom %) and Q_{1.5nm} (atom %) are not limited, but for example, Q_{0.5nm} (atom %) is 1000 (atom %) or more, preferably 1500 (atom %) or more, and more preferably 2000 (atom %) or more, and it may also be 7000 (atom %) or less or may be 6000 (atom %) or less. Q_{1.5nm} (atom %) is, for example, 10 (atom %) or more, preferably 30 (atom %) or more, and more preferably 50 (atom %) or more, and it may also be 1000 (atom %) or less or may be 200 (atom %) or less.

As shown in Examples, which will be described later, the above measurement by XPS can be carried out for each of the following elements: carbon (C1s), nitrogen (Nis), oxygen (O1s), fluorine (F1s), silicon (2p), boron (B1s), phosphorus (P2p), sulfur (S2p), and chlorine (2p), using MgKα as the excitation X-ray, an X-ray output of 110 W, a photoelectron escape angle of 45°, and a pass energy of 50 eV. In the case where the sample is charged up during the measurement, an electron gun for charge neutralization may be used as appropriate, and furthermore, charge neutralization for the chemical shift of the measured spectrum can be performed with a variety of standard samples and others. For example, among the C1s spectra, the spectra based on C—C and C—H structures may be corrected to an energy reference of 284.0 eV.

In addition, as will be described later, the cured film of the present invention may have a concentration gradient such that the organosilicon compound (A) concentration decreases from the surface toward the film thickness direction by appropriately adjusting the temperature and humidity conditions during curing. For example, the cured film of the present invention may also have a characteristic that the F content on the one side surface (W) is greater than the F content at the ¾ depth. It may have the aforementioned characteristic in place of the F content and O content specified in the present invention, or it may have the aforementioned characteristic together with the F content and O content.

The cured film of the present invention has a structure derived from the organosilicon compound (A). As mentioned above, in the preferred aspect, the above organosilicon compound (A) has a hydrolyzable group or a hydroxy group bonded to a silicon atom (this may be bonded via a linking group), and —SiOH that the organosilicon compound (A) has or —SiOH groups (Si and OH may be bonded via a linking group, the same applies hereinafter) of the organosilicon compound (A) generated by hydrolysis undergo dehydration condensation by themselves, and thus it is usually preferable for the cured film to have a condensed structure derived from the organosilicon compound (A). It is also preferable that the cured film include a condensed structure formed by dehydration condensation between —SiOH groups derived from the organosilicon compound (A) and —SiOH groups derived from another compound or active hydrogen (hydroxy groups or others) on the surface where the cured film (r) is to be formed.

The cured film also has a structure derived from the organosilicon compound (C). As mentioned above, in the preferred aspect, a hydrolyzable group is bonded to a silicon atom of the organosilicon compound (C), and —SiOH groups of the organosilicon compound (C) generated by hydrolysis of hydrolyzable groups undergo dehydration condensation by themselves, and thus it is preferable for the cured film to have a condensed structure derived from the organosilicon compound (C). It is also preferable that the cured film include a condensed structure formed by dehydration condensation between —SiOH groups (Si and OH may be bonded via a linking group. The same applies hereinafter.) derived from the organosilicon compound (C) and —SiOH groups derived from another compound or active hydrogen (hydroxy groups or others) on the surface where the cured film is to be formed.

Furthermore, in the case where the organosilicon compound (B) is mixed in the mixed composition, the organosilicon compound (B) represented by the above formula (b1) has a hydrolyzable group or a hydroxy group represented by A², and —SiOH that the organosilicon compound (B) has or —SiOH groups of the organosilicon compound (B) generated by hydrolysis undergo dehydration condensation with —SiOH groups derived from the organosilicon compound (A), other —SiOH groups derived from the organosilicon compound (B), or active hydrogen (hydroxy groups or others) on the surface where the cured film is to be formed, and thus, in the preferred aspect, the cured film has a condensed structure derived from the organosilicon compound (B) together with the condensed structure derived from the organosilicon compound (A).

The cured film of the present invention, which can be formed in one step (application and curing of one liquid), is thin in thickness and can also achieve the effect of a small surface roughness.

The thickness of the cured film is preferably less than 15 nm, more preferably 2 nm or more and 10 nm or less, still more preferably 3 nm or more and 8 nm or less, and particularly preferably 4 nm or more and 6 nm or less.

The roughness Ra of the surface (W) is preferably 40 nm or less, more preferably 20 nm or less, still more preferably 10 nm or less, further preferably 5 nm or less, still further preferably 4 nm or less, particularly preferably 3 nm or less, and further particularly preferably 2 nm or less, and it may also be 0.2 nm or more. The aforementioned roughness means the surface arithmetic mean roughness Ra, which can be obtained by measurement through laser microscope observation or surface observation using a microscope such as a scanning probe microscope, and calculation in accordance with JIS B0601.

Also, the contact angle of water on the surface (W) is preferably 113° or more, more preferably 114° or more, still more preferably 115° or more, and further preferably 116° or more, and it may also be 125° or less. The contact angle of water is measured by dropping a water droplet of 3 μL on the surface (W) and using the method by the droplet method.

The cured film of the present invention has good wear resistance, and after carrying out a wear resistance test in which the film surface is rubbed with a load of 200 g per 1.5 cm×1.5 cm area on the surface (W), the maximum number of times of wear where the contact angle is greater than 100° can be 20,000 times or more, more preferably 25,000 times or more, and still more preferably 30,000 times or more. When rubbing, it is preferable to rub with paper made of a pulp material, and it is more preferable to rub with paper made of a pulp material attached to an elastic material. The stroke distance of the wear resistance test is, for example, 30 mm, the rubbing speed is 90 back and forth/minute, and the contact angle may be measured at the approximate center of the stroke area.

The cured film of the present invention can also achieve the effect of being colorless and transparent and having good appearance.

The cured film of the present invention can be formed by applying the above mixed composition to a base material and curing it. Examples of the base material include a substrate (s) and a layer (X), which will be described below. Examples of the method for applying the mixed composition to the base material include the dip coating method, the roll coating method, the bar coating method, the spin coating method, the spray coating method, the die coating method, and the gravure coating method. The cured film (r) can be formed by applying the mixed composition and then heating and drying at a temperature of higher than 60° C. and 90° C. or lower for 20 minutes to 2 hours (preferably 20 minutes to 60 minutes). In addition, in order to obtain the cured film of the present invention, it is preferable to adjust the volatilization speed of solvents, and for example, it is important to appropriately adjust the humidity conditions upon forming a film from or heating and drying the mixed composition, and it is preferable to set the relative humidity to 35% or more, and more preferably to 40% or more, and it may also be 60% or less or may be 50% or less.

3. Laminated Body

The present invention also encompasses a laminated body that includes the cured film and a substrate (s). It is preferable that the cured film and the substrate (s) be laminated via a layer (X).

3-1. Substrate (s)

The material of the substrate (s) of the present invention is not particularly limited and may be either an organic material or an inorganic material, and the shape of the substrate may be either flat or curved, or may be a combination thereof. Examples of the organic material include a resin including the following: a thermoplastic resin such as acrylic resin, acrylonitrile resin, polycarbonate resin, polyester resin (such as polyethylene terephthalate), styrene resin, cellulose resin, polyolefin resin, vinyl resin (such as polyethylene, polyvinyl chloride (that is, vinyl chloride resin), vinylbenzyl chloride resin, and polyvinyl alcohol), polyvinylidene chloride resin, polyamide resin, polyimide resin, polyamideimide resin, polyetherimide resin, polyethersulfone resin, polysulfone resin, polyvinylalcohol resin, polyvinylacetal resin, and copolymer thereof; and a thermosetting resin such as phenolic resin, urea resin, melamine resin, epoxy resin, unsaturated polyester, silicone resin, and urethane resin. Examples of the inorganic material include a metal such as iron, silicon, copper, zinc, and aluminum or an alloy containing these metals, a ceramic, and glass. Among the above, in particular, the organic material is preferred. At least one of acrylic resin, polyester resin, vinylbenzyl chloride resin, epoxy resin, silicone resin, and urethane resin is preferred, acrylic resin and polyester resin are more preferred, and polyethylene terephthalate is particularly preferred.

It is also preferable to disperse inorganic particles, organic particles, or rubber particles in the substrate (s), and it may also contain a compounding agent such as a colorant like pigment or dye, a fluorescent brightening agent, a dispersing agent, a plasticizer, a thermal stabilizer, a light stabilizer, an infrared absorber, an ultraviolet absorber, an antistatic agent, an antioxidant, a lubricant, or a solvent.

The thickness of the substrate (s) is, for example, 5 μm or more, preferably 10 μm or more, more preferably 20 μm or more, and still more preferably 30 μm or more, and it may be 8 mm or less, preferably 7 mm or less, more preferably 6.5 mm or less, still more preferably 6 mm or less, and it is also preferably 500 μm or less, 200 μm or less, 150 μm or less, 100 μm or less, or 60 μm or less.

3-2. Layer (X)

In the laminated body of the present invention, it is preferable that the substrate (s) and the cured film (r) be laminated via the layer (X) that is different from the substrate (s) and the cured film (r). Examples of the layer (X) include a layer formed from at least one selected from a group (X1) consisting of an active energy ray curable resin and a thermosetting resin. The active energy ray is defined as an energy ray that can decompose an active species-generating compound to generate active species. Examples of the active energy ray may include visible light, ultraviolet rays, infrared rays, X-rays, α-rays, β-rays, γ-rays, and electron beams. Examples of the active energy curable resin include an ultraviolet ray curable resin such as acrylic resin, epoxy resin, oxetane resin, urethane resin, polyamide resin, vinylbenzyl chloride resin, vinyl resin (such as polyethylene and vinyl chloride resin), styrene resin, phenolic resin, vinyl ether resin or silicone resin, or a mixed resin thereof, and an electron beam curable resin, and in particular, an ultraviolet curable resin is preferred. Examples of the layer (X) may also include a layer formed from at least one selected from a group (X2) consisting of titanium oxide, zirconium oxide, aluminum oxide, niobium oxide, tantalum oxide, lanthanum oxide, and SiO₂. As the group (X1), in particular, an acrylic resin, a silicone resin, a styrene resin, a vinyl chloride resin, a polyamide resin, a phenolic resin, and an epoxy resin are preferred, and by using the resins listed above as the group (X1), the roughness Ra of the surface (W) can be reduced. As the group (X2), SiO₂ is preferred. The thickness of the layer (X) is, for example, 0.1 nm or more and 100 μm or less, preferably 1 nm or more and 60 μm or less, and more preferably 1 nm or more and 10 μm or less.

3-2-1. Hard Coat Layer (Hc)

In the case where the layer (X) is formed from at least one selected from the group (X1), the layer (X) can function as a hard coat layer (hc) having surface hardness and can impart scratch resistance to the substrate (s). The hardness of the hard coat layer (hc) is usually B or higher in pencil hardness, preferably HB or higher, still more preferably H or higher, and especially preferably 2H or higher. In the case where the layer (X) includes the hard coat layer (hc), that is, in the case where the layer (X) has the function of a hard coat layer, the hard coat layer (hc) may have a single layer structure or may have a multilayer structure. It is preferable for the hard coat layer (hc) to contain, for example, the aforementioned ultraviolet ray curable resin, particularly preferable to contain an acrylic resin or a silicone resin, and preferable to contain an acrylic resin in order to express high hardness. In addition, it is also preferable to contain an epoxy resin, as the tendency is observed to have good close adhesion between the substrate (s) and the cured film (r). Note that the specific method for forming the active energy ray curable resin and the thermosetting resin that constitute the group (X1) will be described in the display device section, which will be described later.

In the case where the layer (X) includes the hard coat layer (hc), the hard coat layer (hc) may contain an additive. The additive is not limited, and examples thereof include inorganic particulates, organic particulates, or a mixture thereof. Examples of the additive may include an ultraviolet absorber, a metal oxide such as silica or alumina, or an inorganic filler such as polyorganosiloxane. By containing the inorganic filler, the close adhesion between the substrate (s) and the cured film (r) can be improved. The thickness of the hard coat layer (hc) is, for example, 1 μm or more and 100 μm or less, preferably 2 μm or more and 100 μm or less. In the case where the thickness of the hard coat layer (hc) is 1 μm or more, sufficient scratch resistance can be ensured, and in the case where the thickness is 100 μm or less, bending resistance can be ensured and as a result, curl generation due to curing shrinkage can be suppressed.

3-2-2. Antireflection Layer (Ar)

In the case where the layer (X) is formed from at least one selected from the group (X2), the layer (X) can function as an antireflection layer (ar) that prevents reflection of the incident light. In the case where the layer (X) includes the antireflection layer (ar), it is preferable that the antireflection layer (ar) be a layer that exhibits reflection characteristics where the reflectance is reduced to about 5.0% or less in the visible light region of 380 to 780 nm. It is preferable for the layer (X) to include a layer formed from silica.

The structure of the antireflection layer (ar) is not particularly limited and it may be a single layer structure or may be a multilayer structure. In the case of a multilayer structure, a structure in which a low refractive index layer and a high refractive index layer are alternately laminated is preferred, and it is preferable that the number of lamination be 2 to 20 in total. Examples of the material constituting the high refractive index layer include titanium oxide, zirconium oxide, aluminum oxide, niobium oxide, tantalum oxide, or lanthanum oxide, while examples of the material constituting the low refractive index layer include silica. As the antireflection layer with a multilayer structure, a structure is preferred in which SiO₂ (silica) and ZrO₂, or SiO₂ and Nb₂O₅ are alternately laminated, and the outermost layer on the opposite side of the substrate (s) is SiO₂. The antireflection layer (ar) can be formed by, for example, the vapor deposition method. The thickness of the antireflection layer (ar) is, for example, 0.1 nm to 5 μm.

The layer (X) may include both the hard coat layer (hc) and the antireflection layer (ar), and in this case, as for the laminated body of the present invention, it is preferable that the layers be laminated in the following order from the substrate side: substrate (s), hard coat layer (hc), antireflection layer (ar), and cured film (r). In the case where the layer (X) is formed from at least one selected from the group (X1), the layer (X) can be formed by, for example, applying a mixed composition constituting the layer (X) to the substrate (s) and irradiating it with heat or active energy rays such as ultraviolet rays. Also, in the case where the layer (X) is formed from at least one selected from the group (X2), the layer (X) can be formed by, for example, the vapor deposition method.

4. Method for Producing Laminated Body

As for the laminated body of the present invention, after forming the layer (X) described above on the substrate (s) if necessary, the cured film of the present invention may be formed by the above-mentioned method.

Before forming the cured film of the present invention, it is preferable to perform easy adhesion treatment on the substrate (s) or the layer (X) provided on the substrate (s). Examples of the easy adhesion treatment include hydrophilization treatment such as corona treatment, plasma treatment, and ultraviolet treatment. By carrying out the easy adhesion treatment such as plasma treatment, functional groups can be formed on the surface of the substrate, such as OH groups (especially when the substrate is an epoxy resin) or COOH groups (especially when the substrate is an acrylic resin), and the close adhesion between the substrate (s) or layer (X) and the cured film is further improved. In particular, it is preferable to carry out the easy adhesion treatment on the substrate (s) or on the layer (X) formed from the group (X1).

In the case where the layer (X) is formed from at least one selected from the group (X1), the layer (X) can be formed by, for example, applying a mixed composition constituting the layer (X) to the substrate (s) and curing it with heat or active energy rays such as ultraviolet rays. Also, in the case where the layer (X) is formed from at least one selected from the group (X2), the layer (X) can be formed by, for example, the vapor deposition method.

5. Display Device

The laminated body of the present invention is suitably used for display devices. The laminated body of the present invention can preferably be used as a front plate in a display device, and the front plate may be referred to as a window film.

It is preferable that the display device be composed of a laminated body for display devices including a window film (that is, the laminated body of the present invention) and an organic EL display panel, in which the laminated body for display devices is disposed on the visible side relative to the organic EL display panel. Also, it is preferable that the flexible display device be composed of a laminated body for flexible display devices including a window film having flexible characteristics and an organic EL display panel, in which the laminated body for flexible display devices is disposed on the visible side relative to the organic EL display panel, and is configured to be bendable. The laminated body for display devices (preferably the laminated body for flexible display devices) may further contain a polarization plate (preferably a circular polarization plate), a touch sensor, and other components to constitute a touch panel display, and the order in which they are laminated is arbitrary, but it is preferable that they be laminated from the visible side in the order of window film, polarization plate, and touch sensor, or in the order of window film, touch sensor, and polarization plate. When the polarization plate is present on the visible side relative to the touch sensor, the pattern of the touch sensor is less visible and the visibility of displayed images is improved, which is preferable. Each member can be laminated using an adhesive, a gluing agent, and other methods. The flexible display device can also be equipped with a light shielding pattern formed on at least one side of any layer of the window film, the polarization plate, and the touch sensor.

(Window Film)

The window film is disposed on the visible side of the display device (preferably the flexible image display device) and plays the role of protecting the other components from external impacts or environmental changes in temperature, humidity, and other factors. As such a protective layer, glass may be used, and in the flexible image display device, the material of the window film used may be one having flexible characteristics, rather than rigid and firm material such as glass. Accordingly, when using the laminated body of the present invention as the window film in the flexible display device, it is preferable that the substrate (s) have a layer composed of a flexible transparent substrate, and the substrate (s) may have a multilayer structure in which a hard coat layer is laminated on at least one side thereof.

The transparent substrate has a transmittance of visible light of, for example, 70% or more, preferably 80% or more. As the transparent substrate, any material can be used as long as it is a transparent polymer film. Specifically, it may be a film formed of the following polymers: polyolefins such as polyethylene, polypropylene, polymethylpentene, and cycloolefin derivatives having monomer units including norbornene or cycloolefins; (modified) celluloses such as diacetyl cellulose, triacetyl cellulose, and propionyl cellulose; acrylics such as methyl methacrylate (co)polymers; polystyrenes such as styrene (co)polymers; acrylonitrile-butadiene-styrene copolymers; acrylonitrile-styrene copolymers; ethylene-vinyl acetate copolymers; polyvinyl chlorides; polyvinylidene chlorides; polyesters such as polyethylene terephthalate, polybutylene terephthalate, polyethylene naphthalate, polycarbonate, and polyarylate; polyamides such as nylon; polyimides; polyamideimides; polyetherimides; polyethersulfones; polysulfones; polyvinyl alcohols; polyvinyl acetals; polyurethanes; and epoxy resins, and an unstretched uniaxially or biaxially stretched film can be used. These polymers can each be used alone, or two or more types can be used in mixture. Preferably, among the aforementioned transparent substrates, the polyamide film, polyamideimide film or polyimide film, polyester film, olefin film, acrylic film, and cellulose film are preferred because of their excellent transparency and heat resistance. It is also preferable to disperse inorganic particles such as silica, organic particles, rubber particles, and others in the polymer film. Furthermore, it may contain a compounding agent such as a colorant like pigment or dye, a fluorescent brightening agent, a dispersing agent, a plasticizer, a thermal stabilizer, a light stabilizer, an infrared absorber, an ultraviolet absorber, an antistatic agent, an antioxidant, a lubricant, or a solvent. The thickness of the transparent substrate is 5 μm or more and 200 μm or less, preferably 20 μm or more and 100 μm or less. Especially in the case where it is used in the flexible image display device, the thickness of the transparent substrate is preferably 5 μm or more and 60 μm or less.

The hard coat layer in the case where the laminated body of the present invention is used as the window film is also the same as the hard coat layer (hc) described above. As mentioned above, it is preferable that the hard coat layer (hc) be formed from an active energy ray curable resin and a thermosetting resin, and such resins can be formed by curing a hard coat composition containing a reactive material that forms a crosslinked structure upon irradiation with active energy rays or thermal energy. The hard coat composition contains a polymerized product of at least one of a radical polymerizable compound and a cationic polymerizable compound.

The radical polymerizable compound is a compound having a radical polymerizable group. The radical polymerizable group that the radical polymerizable compound has may be any functional group that can cause a radical polymerization reaction, and examples thereof include a group containing a carbon-carbon unsaturated double bond. Specific examples thereof include a vinyl group and a (meth)acryloyl group. Note that, in the case where the radical polymerizable compound has two or more radical polymerizable groups, these radical polymerizable groups may be the same as or different from each other. It is preferable that the number of radical polymerizable groups that the radical polymerizable compound has in one molecule be two or more from the point of improving the hardness of the hard coat layer. As the radical polymerizable compound, a compound having a (meth)acryloyl group is particularly preferred from the point of high reactivity, and a compound referred to as a multifunctional acrylate monomer having 2 to 6 (meth)acryloyl groups in one molecule, or an oligomer with a molecular weight of hundreds to thousands having several (meth)acryloyl groups in the molecule, referred to as epoxy (meth)acrylate, urethane (meth)acrylate, or polyester (meth)acrylate, can be preferably used. It is preferable to include one or more selected from epoxy (meth)acrylate, urethane (meth)acrylate, and polyester (meth)acrylate.

The cationic polymerizable compound is a compound having a cationic polymerizable group such as an epoxy group, an oxetanyl group, and a vinyl ether group. The number of cationic polymerizable groups that the cationic polymerizable compound has in one molecule is preferably two or more, and still more preferably three or more, from the point of improving the hardness of the hard coat layer. Also, as the cationic polymerizable compound, a compound having at least one of epoxy group and oxetanyl group as the cationic polymerizable group is particularly preferred. A cyclic ether group, such as an epoxy group or an oxetanyl group, is preferred from the point that shrinkage associated with the polymerization reaction is small. In addition, a compound having an epoxy group among cyclic ether groups has the advantages that compounds with a wide variety of structures are readily available, the durability of the obtained hard coat layer is not adversely affected, and compatibility with the radical polymerizable compound is easily controlled. Also, an oxetanyl group among cyclic ether groups has the advantages that its degree of polymerization tends to be higher compared to an epoxy group, it is less toxic, it accelerates the network formation speed obtained from the cationic polymerizable compound in the obtained hard coat layer, and it forms independent networks without leaving unreacted monomers in the film even in the area mixed with the radical polymerizable compound, for example.

Examples of the cationic polymerizable compound having an epoxy group include an alicyclic epoxy resin obtained by epoxidizing a polyglycidyl ether of a polyhydric alcohol having an alicyclic ring or a cyclohexene ring- or cyclopentene ring-containing compound with an appropriate oxidizing agent such as hydrogen peroxide or a peracid; an aliphatic epoxy resin such as a polyglycidyl ether of an aliphatic polyhydric alcohol or an alkylene oxide adduct thereof, a polyglycidyl ester of an aliphatic long-chain polybasic acid, and a homopolymer or copolymer of glycidyl (meth)acrylate; and a glycidyl ether epoxy resin derived from a glycidyl ether produced through the reaction of bisphenols such as bisphenol A, bisphenol F, and hydrogenated bisphenol A, or derivatives thereof such as alkylene oxide adducts and caprolactone adducts, with epichlorohydrin, and bisphenols, such as a novolac epoxy resin.

The hard coat composition can further contain a polymerization initiator. Examples of the polymerization initiator include a radical polymerization initiator, a cationic polymerization initiator, and a radical and cationic polymerization initiator, which can be selected and used as appropriate. These polymerization initiators are decomposed by at least one of irradiation with active energy rays and heating to generate radicals or cations to proceed radical polymerization and cationic polymerization.

The radical polymerization initiator may be anything as long as it is capable of releasing a substance that initiates radical polymerization by at least any of irradiation with active energy rays and heating. Examples of the thermal radical polymerization initiator include hydrogen peroxide, an organic peroxide such as perbenzoic acid, and an azo compound such as azobisbutyronitrile.

Examples of the active energy ray radical polymerization initiator include a Type 1 radical polymerization initiator, which generates radicals by molecular decomposition, and a Type 2 radical polymerization initiator, which coexists with a tertiary amine and generates radicals by a hydrogen abstraction reaction, each of which can also be used alone or in combination.

The cationic polymerization initiator may be anything as long as it is capable of releasing a substance that initiates cationic polymerization by at least any of irradiation with active energy rays and heating. As the cationic polymerization initiator, an aromatic iodonium salt, an aromatic sulfonium salt, a cyclopentadienyl iron(II) complex, and others can be used. They can initiate cationic polymerization by either irradiation with active energy rays or heating, or by both of them, depending on the difference in structure.

The polymerization initiator can be contained in an amount of 0.1 to 10% by weight relative to 100% by weight of the entire hard coat composition. In the case where the content of the polymerization initiator is less than 0.1% by weight, curing cannot progress sufficiently and it is difficult to realize the mechanical properties and close adhesion strength of the finally obtained coating film, and in the case where the content exceeds 10% by weight, poor adhesive force due to curing shrinkage, a breakage phenomenon, and a curling phenomenon may occur.

The hard coat composition can further contain one or more selected from the group consisting of a solvent and an additive. The solvent is one that can dissolve or disperse the polymerizable compound and the polymerization initiator, and any solvent can be used without restrictions as long as it is known as a solvent for hard coat compositions in the present technical field. The additive can further include an inorganic particle, a leveling agent, a stabilizer, a surfactant, an antistatic agent, a lubricant, an antifouling agent, and others.

(Circular Polarization Plate)

It is preferable for the display device (preferably the flexible display device) of the present invention to comprise a polarization plate, particularly a circular polarization plate, as described above. The circular polarization plate is a functional layer that has a function of transmitting only right- or left-handed circularly polarized light component by laminating a λ/4 phase difference plate on a linear polarization plate. For example, it is used in order to suppress the influence of reflected light and make images easier to see by converting outside light to right-handed circularly polarized light, blocking outside light that has been reflected by the organic EL panel and become left-handed circularly polarized light, and transmitting only the emissive component of the organic EL. In order to achieve the circular polarization function, the absorption axis of the linear polarization plate and the retardation axis of the λ/4 phase difference plate needs to be theoretically 45 degrees, but for practical purposes, 45±10 degrees. The linear polarization plate and the λ/4 phase difference plate do not necessarily need to be laminated adjacent to each other, as long as the relationship between the absorption axis and the retardation axis satisfies the aforementioned range. Although it is preferable to achieve perfect circular polarization at all wavelengths, this is not always necessary for practical purposes, and therefore the circular polarization plate in the present invention encompasses an elliptical polarization plate as well. It is also preferable to improve visibility in the state of wearing polarization sunglasses by further laminating a λ/4 phase difference film on the visible side of the linear polarization plate to make the emitted light circularly polarized light.

The linear polarization plate is a functional layer that allows light oscillating in the direction of the transmission axis to pass through, but has a function to block polarized light of an oscillating component perpendicular to it. The linear polarization plate may have a configuration comprising a linear polarizer alone or a linear polarizer and a protective film pasted onto at least one side thereof. The thickness of the linear polarization plate may be 200 μm or less, and is preferably 0.5 μm or more and 100 μm or less. When the thickness of the linear polarization plate is in the aforementioned range, the flexibility of the linear polarization plate tends to be difficult to decrease.

The linear polarizer may be a film-type polarizer produced by dyeing and stretching a polyvinyl alcohol (hereinafter, this may be abbreviated as PVA) film. A dichroic pigment such as iodine is adsorbed on the PVA film oriented by stretching, or the film is stretched with the dichroic pigment adsorbed on the PVA, resulting in orientation of the dichroic pigment and polarization performance. The production of the film-type polarizer may have other steps such as swelling, crosslinking with boric acid, washing with an aqueous solution, and drying. The stretching and dyeing steps may be performed on the PVA film alone or in the state where the film is laminated with another film (resin substrate for stretching), such as polyethylene terephthalate. The thickness of the PVA film used is preferably 3 to 100 μm, and the stretching ratio is preferably 2 to 10 times. As the method for fabricating a laminated body of a resin substrate for stretching and a PVA resin layer, a method is preferred in which an application liquid containing the PVA resin is applied to the surface of the resin substrate for stretching, and then dried.

In particular, when the production method includes a step of stretching the PVA resin layer and the resin substrate for stretching in the state of a laminated body and a step of dyeing it, it is possible to perform stretching without problems such as rupture due to stretching because the PVA resin layer is supported by the resin substrate for stretching, even if the PVA resin layer is thin.

The thickness of the polarizer is 20 μm or less, preferably 12 μm or less, more preferably 9 μm or less, still more preferably 1 to 8 μm, and particularly preferably 3 to 6 μm. Within the aforementioned range, it is a preferred aspect without inhibiting bending.

Furthermore, another example of the polarizer is a liquid crystal-applied polarizer that is formed by applying a liquid crystal polarization composition. The liquid crystal polarization composition can contain a liquid crystalline compound and a dichroic pigment compound. The liquid crystalline compound may be anything as long as it has the property of exhibiting a liquid crystalline state, and in particular, it is preferable that the compound have a highly oriented state, such as a smectic phase, thereby achieving high polarization performance. It is also preferable that the liquid crystalline compound have a polymerizable functional group.

The dichroic pigment compound is a pigment that is oriented together with the liquid crystalline compound to exhibit dichroism and may have a polymerizable functional group, or the dichroic pigment itself may have liquid crystallinity.

Any of the compounds contained in the liquid crystal polarization composition has a polymerizable functional group. The liquid crystal polarization composition can further contain an initiator, a solvent, a dispersing agent, a leveling agent, a stabilizer, a surfactant, a crosslinking agent, a silane coupling agent, and others.

The liquid crystal polarization layer is produced by applying the liquid crystal polarization composition onto an oriented film to form a liquid crystal polarization layer. The liquid crystal polarization layer can be formed to be thinner compared to the film-type polarizer, and its thickness is preferably 0.5 μm or more and 10 μm or less, and more preferably 1 μm or more and 5 μm or less.

The oriented film is produced by, for example, applying an oriented film-forming composition onto a substrate and imparting orientation by rubbing, polarized light irradiation, or other means. The oriented film-forming composition contains an orientation agent, and may further contain a solvent, a crosslinking agent, an initiator, a dispersing agent, a leveling agent, a silane coupling agent, and others. Examples of the orientation agent include a polyvinyl alcohol, a polyacrylate, a polyamic acid, and a polyimide. In the case of using an orientation agent that imparts orientation by polarized light irradiation, it is preferable to use an orientation agent that contains a cinnamate group. The weight average molecular weight of the polymer used as the orientation agent is, for example, about 10,000 to 1,000,000. The thickness of the oriented film is preferably 5 nm or more and 10,000 nm or less, and from the point that the orientation-regulating force is sufficiently expressed, more preferably 10 nm or more and 500 nm or less.

The liquid crystal polarization layer can be peeled off from the substrate, transferred, and laminated, or the substrate can be laminated as it is. It is also preferable that the substrate play the role as a protective film, a phase difference plate, and a transparent substrate for the window film.

The protective film may be anything as long as it is a transparent polymer film, and the same materials and additives used for the transparent substrate for the window film can be used. A cellulose film, an olefin film, an acrylic film, and a polyester film are preferred. It may also be a coating-type protective film obtained by applying and curing a cation curable composition such as epoxy resin or a radical curable composition such as acrylate. The protective film may contain, if necessary, a plasticizer, an ultraviolet absorber, an infrared absorber, a colorant like pigment or dye, a fluorescent brightening agent, a dispersing agent, a thermal stabilizer, a light stabilizer, an antistatic agent, an antioxidant, a lubricant, a solvent, and others. The thickness of the protective film is preferably 200 μm or less, and more preferably 1 μm or more and 100 μm or less. When the thickness of the protective film is in the aforementioned range, the flexibility of the film tends to be difficult to decrease. The protective film can also serve the role of the transparent substrate for the window film.

The λ/4 phase difference plate is a film that provides λ/4 phase difference in the direction perpendicular to the direction of incident light travel (in-plane direction of the film). The λ/4 phase difference plate may be a stretched phase difference plate produced by stretching a polymer film such as cellulose film, olefin film, and polycarbonate film. The λ/4 phase difference plate may contain, if necessary, a phase difference adjuster, a plasticizer, an ultraviolet absorber, an infrared absorber, a colorant like pigment or dye, a fluorescent brightening agent, a dispersing agent, a thermal stabilizer, a light stabilizer, an antistatic agent, an antioxidant, a lubricant, a solvent, and others.

The thickness of the stretched phase difference plate is preferably 200 μm or less, and more preferably 1 μm or more and 100 μm or less. When the thickness of the stretched phase difference plate is in the aforementioned range, the flexibility of the stretched phase difference plate tends to be difficult to decrease.

Furthermore, another example of the λ/4 phase difference plate is a liquid crystal-applied phase difference plate that is formed by applying a liquid crystal composition.

The liquid crystal composition includes a liquid crystalline compound that exhibits a liquid crystalline state such as nematic, cholesteric, and smectic. The liquid crystalline compound has a polymerizable functional group.

The liquid crystal composition can further contain an initiator, a solvent, a dispersing agent, a leveling agent, a stabilizer, a surfactant, a crosslinking agent, a silane coupling agent, and others.

In the same manner as for the liquid crystal polarization layer, the liquid crystal-applied phase difference plate can be produced by applying the liquid crystal composition onto the foundation and curing it to form the liquid crystal phase difference layer. The liquid crystal-applied phase difference plate can be formed to be thinner compared to the stretched phase difference plate. The thickness of the liquid crystal polarization layer is preferably 0.5 μm or more and 10 μm or less, and more preferably 1 μm or more and 5 μm or less.

The liquid crystal-applied phase difference plate can be peeled off from the substrate, transferred, and laminated, or the substrate can be laminated as it is. It is also preferable that the substrate play the role as a protective film, a phase difference plate, and a transparent substrate for the window film.

In general, many materials exhibit greater birefringence at shorter wavelengths and smaller birefringence at longer wavelengths. In this case, it is not possible to achieve λ/4 phase difference in the entire visible light region, and therefore, in order to achieve λ/4 with respect to around 560 nm where the visual sensitivity is high, the in-plane phase difference is designed to be preferably 100 nm or more and 180 nm or less, and more preferably 130 nm or more and 150 nm or less. An inverse dispersion λ/4 phase difference plate using a material having birefringence index wavelength dispersion characteristics opposite to the usual is preferred from the point that the visibility is good. As such materials, for example, those disclosed in Japanese Patent Laid-Open No. 2007-232873 and others can be used for the stretched phase difference plate, and those disclosed in Japanese Patent Laid-Open No. 2010-30979 and others can be used for the liquid crystal-applied phase difference plate.

In addition, as another method, a technique to obtain a broadband λ/4 phase difference plate by combining with a λ/2 phase difference plate is also known (for example, Japanese Patent Laid-Open No. 10-90521 and others). The λ/2 phase difference plate is also produced using the same materials and methods as for the λ/4 phase difference plate. The combination of stretched phase difference plate and liquid crystal-applied phase difference plate is arbitrary, but by using the liquid crystal-applied phase difference plate for both, the thickness can be made thinner.

The method of laminating a positive C-plate on the circular polarization plate is known in order to enhance visibility in the diagonal direction (for example, Japanese Patent Laid-Open No. 2014-224837 and others). The positive C-plate may be the liquid crystal-applied phase difference plate, or may be the stretched phase difference plate. The phase difference in the thickness direction of the phase difference plate is preferably −200 nm or more and −20 nm or less, and more preferably −140 nm or more and −40 nm or less.

(Touch Sensor)

It is preferable for the display device (preferably the flexible display device) comprising the laminated body of the present invention to comprise a touch sensor, as described above. The touch sensor is used as an input means. Examples of the touch sensor include a variety of styles, such as resistive film system, surface acoustic wave system, infrared system, electromagnetic induction system, and electrostatic capacitance system, and preferably electrostatic capacitance system.

The electrostatic capacitive touch sensor is divided into an active area and an inactive area positioned on the outline of the active area. The active area is an area corresponding to the area on the display panel where the screen is displayed (display area) and where the touches by the user are sensed, while the inactive area is an area corresponding to the area on the display device where the screen is not displayed (non-display area). The touch sensor can include a substrate preferably having flexible characteristics, a sensing pattern formed in the active area of the substrate, and each sensing line formed in the inactive area of the substrate for connecting the sensing pattern to an external drive circuit via a pad section. As the substrate having flexible characteristics, the same materials as for the transparent substrate for the window film can be used. As the substrate of the touch sensor, one with a toughness of 2,000 MPa % or more is preferred in terms of suppressing cracks in the touch sensor. More preferably, the toughness is 2,000 MPa % or more and MPa % or less. Here, the toughness is defined as the lower area of the stress (MPa)-strain (%) curve (stress-strain curve) up to the fracture point, which is obtained through a tensile experiment on a polymeric material.

The sensing pattern can comprise a first pattern formed in a first direction and a second pattern formed in a second direction. The first pattern and the second pattern are disposed in directions different from each other. The first pattern and the second pattern are formed in the same layer, and each pattern must be electrically connected in order to sense the point to be touched. The first pattern is in the form of multiple unit patterns connected to each other via joints, while the second pattern is in the structure of multiple unit patterns separated from each other in the form of islands, and thus separate bridge electrodes are required in order to electrically connect the second pattern. Well known transparent electrodes can be applied to the electrodes for the connection of the second pattern. Examples of the material for the transparent electrodes include indium tin oxide (ITO), indium zinc oxide (IZO), zinc oxide (ZnO), indium zinc tin oxide (IZTO), indium gallium zinc oxide (IGZO), cadmium tin oxide (CTO), PEDOT (poly(3,4-ethylenedioxythiophene)), carbon nanotubes (CNT), graphene, and metal wires, and preferably ITO. They can be used alone, or two or more types can be used in mixture. The metal used for the metal wires is not particularly limited and examples thereof include silver, gold, aluminum, copper, iron, nickel, titanium, tellurium, and chromium. They can be used alone, or two or more types can be used in mixture.

The bridge electrodes can be formed on top of the sensing pattern via an insulating layer and on top of the insulating layer, or the bridge electrodes can be formed on the substrate and the insulating layer and the sensing pattern can be formed on top of it. The bridge electrodes can also be formed from the same material as the sensing pattern, and they can also be formed from molybdenum, silver, aluminum, copper, palladium, gold, platinum, zinc, tin, titanium, or an alloy of two or more of these metals.

Since the first pattern and the second pattern must be electrically isolated, an insulating layer is formed between the sensing pattern and the bridge electrodes. The insulating layer can be formed only between the first pattern joints and the bridge electrodes, or can also be formed as a layer covering the entire sensing pattern. In the case where the insulating layer is a layer covering the entire sensing pattern, the bridge electrodes can connect the second pattern through contact holes formed in the insulating layer.

The touch sensor can further include an optical adjustment layer between the substrate and the electrodes as a means to appropriately compensate for the difference in transmittance between the pattern area where the sensing pattern is formed and the non-pattern area where the sensing pattern is not formed, specifically, the difference in light transmittance induced by the difference in refractive index in these areas. The optical adjustment layer can contain an inorganic insulating substance or an organic insulating substance. The optical adjustment layer can be formed by coating the substrate with a photocurable composition containing a photocurable organic binder and a solvent. The photocurable composition can further contain inorganic particles. The refractive index of the optical adjustment layer can be increased by the inorganic particles.

The photocurable organic binder can contain a copolymer of each monomer, such as acrylate monomer, styrene monomer, and carboxylic acid monomer, to the extent that the effects of the present invention are not impaired. The photocurable organic binder may be, for example, a copolymer containing each repeating unit that differs from each other, such as epoxy group-containing repeating unit, acrylate repeating unit, and carboxylic acid repeating unit.

Examples of the inorganic particles include zirconia particles, titania particles, and alumina particles.

The photocurable composition can also further contain each additive such as a photopolymerization initiator, a polymerizable monomer, and a curing auxiliary agent.

(Adhesive Layer)

Each layer (window film, circular polarization plate, touch sensor) that forms the laminated body for display devices (preferably flexible image display devices) and the film member (linear polarization plate, λ/4 phase difference plate, and others) that constitutes each layer can be joined with an adhesive. As the adhesive, an adhesive and others that are usually used can be used, such as an aqueous adhesive, an organic solvent adhesive, a solventless adhesive, a solid adhesive, a solvent volatilization adhesive, a moisture curable adhesive, a heat curable adhesive, an anaerobic curable adhesive, an active energy ray curable adhesive, a curing agent mixing type adhesive, a hot melt adhesive, a pressure sensitive adhesive (gluing agent), and a remoistening adhesive, and preferably, an aqueous solvent volatilization adhesive, an active energy ray curable adhesive, and a gluing agent can be used. The thickness of the adhesive layer can be adjusted as appropriate depending on the required adhesive force and other factors, and it is preferably 0.01 to 500 μm, and more preferably 0.1 to 300 μm. In the laminated body for display devices (preferably flexible image display devices), there is a plurality of adhesive layers, each of which may be the same or different in thickness and type.

In the aqueous solvent volatilization adhesive, a water soluble polymer such as polyvinyl alcohol polymer and starch, and a polymer in a water dispersion state such as ethylene-vinyl acetate emulsion and styrene-butadiene emulsion can be used as the main agent polymer. In addition to the main agent polymer and water, a crosslinking agent, a silane compound, an ionic compound, a crosslinking catalyst, an antioxidant, a dye, a pigment, an inorganic filler, an organic solvent, and others may also be compounded. In the case of adhesion by the aqueous solvent volatilization adhesive, adhesiveness can be imparted by injecting the aqueous solvent volatilization adhesive between layers to be adhered, pasting the layers to be adhered together, and then drying them. In the case of using the aqueous solvent volatilization adhesive, the thickness of its adhesive layer is preferably 0.01 to 10 μm, and more preferably 0.1 to 1 μm. In the case where the aqueous solvent volatilization adhesive is used in a plurality of layers, the thickness and type of each layer may be the same or different.

The active energy ray curable adhesive can be formed by curing an active energy ray curable composition containing a reactive material that forms an adhesive layer upon irradiation with active energy rays. The active energy ray curable composition can contain a polymerized product of at least one of the same radical polymerizable compound and cationic polymerizable compound as those contained in the hard coat composition. As the radical polymerizable compound, the same compound can be used as the radical polymerizable compound in the hard coat composition.

As the cationic polymerizable compound, the same compound can be used as the cationic polymerizable compound in the hard coat composition.

As the cationic polymerizable compound used in the active energy ray curable composition, an epoxy compound is particularly preferred. In order to lower the viscosity as an adhesive composition, it is also preferable that a monofunctional compound be contained as a reactive diluent.

The active energy ray composition can contain a monofunctional compound to decrease the viscosity. Examples of the monofunctional compound include an acrylate monomer having one (meth)acryloyl group in one molecule and a compound having one epoxy group or oxetanyl group in one molecule, such as glycidyl (meth)acrylate.

The active energy ray composition can further contain a polymerization initiator. Examples of the polymerization initiator include a radical polymerization initiator, a cationic polymerization initiator, and a radical and cationic polymerization initiator, which are selected and used as appropriate. These polymerization initiators are decomposed by at least one of irradiation with active energy rays and heating to generate radicals or cations to proceed radical polymerization and cationic polymerization. An initiator can be used that can initiate at least any of radical polymerization or cationic polymerization by active energy ray irradiation in the description of the hard coat composition.

The active energy ray curable composition can further contain an ion scavenger, an antioxidant, a chain transfer agent, a close adhesion imparting agent, a thermoplastic resin, a filler, a flow viscosity modifier, a plasticizer, a defoamer solvent, an additive, and a solvent. In the case of adhering two layers to be adhered by the active energy ray curable adhesive, they can be adhered by applying the active energy ray curable composition to either one or both of the layers to be adhered, then pasting them together, and irradiating either or both of the layers to be adhered with active energy rays to cure the adhesive. In the case of using the active energy ray curable adhesive, the thickness of its adhesive layer is preferably 0.01 to 20 μm, and more preferably 0.1 to 10 μm. In the case where the active energy ray curable adhesive is used to form a plurality of adhesive layers, the thickness and type of each layer may be the same or different.

As the gluing agent, any of those classified as an acrylic gluing agent, a urethane gluing agent, a rubber gluing agent, a silicone gluing agent, and others can also be used, depending on the main agent polymer. In addition to the main agent polymer, a crosslinking agent, a silane compound, an ionic compound, a crosslinking catalyst, an antioxidant, a tackifier, a plasticizer, a dye, a pigment, an inorganic filler, and others may also be compounded in the gluing agent. By dissolving or dispersing each component constituting the gluing agent in a solvent to obtain a gluing agent composition, applying the gluing agent composition onto a substrate, and then drying it, a gluing agent layer adhesive layer is formed. The gluing agent layer may be directly formed, or it may be separately formed on a substrate and then transferred. It is also preferable to use a release film in order to cover the gluing surface before adhesion. In the case of using the active energy ray curable adhesive, the thickness of its adhesive layer is preferably 0.1 to 500 μm, and more preferably 1 to 300 μm. In the case where the gluing agent is used in a plurality of layers, the thickness and type of each layer may be the same or different.

(Light Shielding Pattern)

The light shielding pattern can be applied as at least part of the bezel or housing of the display device (preferably the flexible image display device). The light shielding pattern hides the wiring disposed at the edge part of the display device (preferably the flexible image display device) and makes it difficult to see, thereby improving the visibility of the image. The light shielding pattern may be in the form of a single layer or multiple layers. The color of the light shielding pattern is not particularly restricted and may be black, white, metallic, or a variety of other colors. The light shielding pattern can be formed with a pigment to realize the color and a polymer such as acrylic resin, ester resin, epoxy resin, polyurethane, or silicone. They can be used alone, or two or more types can also be used in mixture. The light shielding pattern can be formed by a variety of methods, such as printing, lithography, and ink jet printing. The thickness of the light shielding pattern is preferably 1 to 100 μm, and more preferably 2 to 50 μm. In addition, it is also preferable to impart a shape such as slope in the thickness direction of the light shielding pattern.

### EXAMPLES

Hereinafter, the present invention will be described more specifically with reference to Examples. The present invention is not restricted by the following Examples, but can of course be implemented with appropriate modifications to the extent that it may conform to the spirit of the foregoing and the following, all of which are included within the technical scope of the present invention.

### Example 1

A compound (a1) satisfying the above formula (a3) as the organosilicon compound (A) and Novec (R) 7300 as the fluorinated solvent (D1) were mixed, and stirred at room temperature for a certain period of time to obtain a mixed solution (a). In addition, a reaction product of N-2-(aminoethyl)-3-aminopropyltrimethoxysilane and chloropropyltrimethoxysilane (trade name: X-12-5263HP, manufactured by Shin-Etsu Chemical Co., Ltd.) disclosed in Japanese Patent Laid-Open No. 2012-197330, which is represented by the following formula, as the organosilicon compound (C), and isopropanol and butyl acetate as the non-fluorinated solvent (D2) were mixed, and shaken at room temperature for a certain period of time to obtain a mixed solution (c). Furthermore, the mixed solution (a) and the mixed solution (c) were mixed, and mixed using a vortex mixer to obtain a solution for film formation. The mixing ratio is 0.07% by mass of the organosilicon compound (A), 0.08% by mass of the organosilicon compound (C), 78.58% by mass of the fluorinated solvent (D1), and 19.14% by mass (24.34% by volume) of isopropanol and 2.13% by mass (2.42% by volume) of butyl acetate as the non-fluorinated solvent (D2). Note that the compound (a1) is a compound that satisfies not only the requirements for the above-mentioned compounds (a11) and (a21), but also the requirements for formula (a3) including the preferred aspects. Also, in the HSP of X-12-5263HP, dD=15.4, dP=8.1, and dH=9.1; in the HSP of Novec (R) 7300, dD=14.11, dP=5.08, and dH=2.51; in the HSP of isopropanol, dD=15.8, dP=6.1, and dH=16.4; and in the HSP of butyl acetate, dD=15.8, dP=3.7, and dH=6.3. The values for butyl acetate and isopropyl alcohol are the values registered in the database, and the values for Novec 7300 and X-12-5263HP are the values measured by the solubility sphere method, which will be shown below. Note that the units for dD, dP and dH are all (J/cm³)^{0.5}.

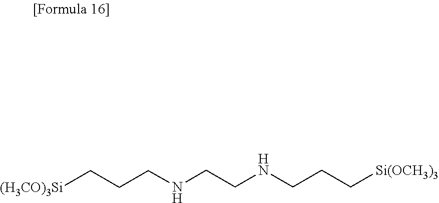

Next, a resin was used as the substrate (s), and the layer (X) (antireflection layer) was laminated on the substrate (s) by the vacuum vapor deposition method, alternately laminating SiO₂ and a metal oxide (but other than SiO₂) such that the surface on the opposite side from the substrate (s) was SiO₂. The total thickness of the substrate (s) and the layer (X) was 84 μm. Using OPTICOAT MS-A100 (bar coater) manufactured by Mikasa Corporation and #2 bar, the solution for film formation was applied onto the layer (X), the applied surface of which had been subjected to activation treatment using an atmospheric pressure plasma device (manufactured by Fuji Machine Mfg. Co., Ltd.), under conditions of 1.0 ml and 100 mm/sec, and dried at 80° C. for 30 minutes to form a cured film and obtain a laminated body in which the substrate (s), the layer (X), and the cured film were laminated in this order. The relative humidity at the time of drying after applying the solution for film formation was 35% to 50%.

### Example 2

In the same manner as in Example 1 except that the layer (X), which was a hard coat layer of an acrylic resin, was laminated on top of the substrate (s) on top of the substrate (s), the solution for film formation was applied onto the layer (X), and the total thickness of the substrate (s) and the layer (X) was 55 μm, a laminated body was obtained.

### Example 3

In the same manner as in Example 2 except that the amount of the compound (a1) as the organosilicon compound (A) was 0.02% by mass, the amount of X-12-5263HP as the organosilicon compound (C) was 0.01% by mass, the amount of Novec 7100 as the fluorinated solvent (D1) was 78.64%, and the amount of isopropanol, butyl acetate, and acetone as the non-fluorinated solvent (D2) was 18.98%, 2.13%, and 0.21%, respectively, a laminated body was obtained.

Note that, in the HSP of Novec (R) 7100, dD=13, dP=2.9, and dH=2.3 as the values registered in the database.

[Measurement of Hansen Solubility Parameters by Solubility Sphere Method]

In a transparent container, 1 mL of a solvent with known solubility parameters as shown in Table 1 (source: Polymer Handbook, 4th Edition) and 1 mL of the target compound were added to prepare a mixed solution. After shaking the obtained mixture, the appearance of the solution was visually observed, and from the obtained observation results, the solubility of the target compound in the solvent was evaluated based on the following evaluation criteria. Note that, in the case where the evaluation criterion was 1 or 2, the solvent was judged to have dissolved the measurement sample, and in the case where the evaluation criterion was 0, the solvent was judged not to have dissolved the measurement sample.

### (Evaluation Criteria)

2: The appearance of the mixed solution is translucent.
1: The appearance of the mixed solution is colorless and transparent.
0: The appearance of the mixed solution is cloudy.

TABLE 1

| | Hansen solubility | | | Evaluation | |
|---|---|---|---|---|---|
| | parameters (J/cm³)^{0.5} | | | Novec | X-12- |
| Solvent type | δD | δP | δH | 7300 | 5263HP |
| Hexane | 14.9 | 0.0 | 0.0 | 1 | 1 |
| HFC-365mfc | 14.1 | 2.5 | 2.1 | 1 | 1 |
| 1-Ethoxy-1,1,2,2,3,3,4,4,4- | 13.1 | 2.8 | 2.1 | 1 | 0 |
| nonafluorobutane | | | | | |
| HFE 7000 | 13.0 | 4.2 | 1.0 | 1 | 2 |
| Hexadecane | 16.3 | 0.0 | 0.0 | 0 | 2 |
| p-Xylene | 17.8 | 1.0 | 3.1 | 1 | 1 |
| Diethyl ether | 14.5 | 2.9 | 4.6 | 0 | |
| Isoamyl acetate | 15.3 | 3.1 | 7.0 | 1 | 1 |
| 2-Propanol | 15.8 | 6.1 | 16.4 | 2 | 1 |
| o-Dichlorobenzene | 19.2 | 6.3 | 3.3 | 0 | |
| Diacetone alcohol | 15.8 | 8.2 | 10.8 | 0 | 1 |
| Diethylene glycol | 16.6 | 12.0 | 19.0 | 0 | 2 |
| Acetonitrile | 15.3 | 18.0 | 6.1 | 0 | |
| Aniline | 20.1 | 5.8 | 11.2 | | 2 |
| Propylene carbonate | 20 | 18 | 4.1 | | 2 |
| Ethylene glycol | 17 | 11 | 26 | | 2 |
| Acetophenone | 18.8 | 9 | 4 | | 1 |
| Dimethyl sulfoxide | 18.4 | 16.4 | 10.2 | | 1 |
| Ethanol | 15.8 | 8.8 | 19.4 | | 1 |
| Methyl isobutyl ketone | 15.3 | 6.1 | 4.1 | 1 | |
| Dimethoxymethane | 15 | 1.8 | 8.6 | 1 | |
| Tetrahydrofuran | 16.8 | 5.7 | 8 | 1 | |
| Dimethylcellosolve | 15.4 | 6 | 6 | 0 | |

From the obtained evaluation results of solubility of the target compound in the solvent, the Hansen sphere was made using the above-mentioned Hansen solubility sphere method. The center coordinates of the obtained Hansen sphere were used as the HSP values.

### Comparative Example 1

A solution for film formation was obtained by mixing in a proportion of 0.085% by mass of a compound represented by the following formula (1) as the organosilicon compound (A), 99.325% by mass of FC 3283 and 0.34% by mass of Novec 7200 as the fluorinated solvent (D1), and 0.25% by mass of KBE-603 as the organosilicon compound (C). Thereafter, in the same manner as in Example 1 except that this solution for film formation was used, a laminated body was obtained.

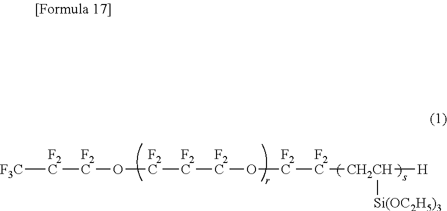

In formula (1), r is about 40, s is 1, and the average molecular weight is about 4000.

For the above Examples and Comparative Example, the following measurements were carried out on the front side of the laminated body, that is, the surface opposite to the substrate.

(1) Measurement of Surface Fluorine Content and Oxygen Content by XPS

The JFS-9010 model manufactured by JEOL Ltd. was used. For the following elements, the escape photoelectron intensity at the film surface was measured using MgKα as the excitation X-ray, an X-ray output of 110 W, a photoelectron escape angle of 30°, and a pass energy of 50 eV: carbon (C1s): 260 to 300 eV, nitrogen (N1s: 390 to 410 eV), oxygen (O1s): 525 to 545 eV, fluorine (F1s): 680 to 698 eV, and silicon (2p): 92 to 112 eV.

In the case where charge-up occurred during the measurement, an electron gun for charge neutralization was used. Furthermore, when carrying out charge neutralization for the chemical shift of the measured spectrum, a standard sample can be used as appropriate, but this time, among the C1s spectra, the spectrum based on C in the C—C structure was corrected to an energy reference of 284.0 eV. The elemental ratio on the surface was measured as described above.

(2) Measurement by PAR-XPS

VG Theta Probe manufactured by Thermo Fisher Scientific was used. The measurement was carried out using monocrystalline spectroscopic AlKα as the irradiation X-ray, an X-ray spot diameter of 800×400 μm (elliptical shape), an angle-resolved lens mode, and a detection angle of 81.13° to 24.88°, divided into 16 sections at a pitch of 3.75°. An electron gun for charge neutralization was used. For the following elements, the profile in the film thickness direction of the escape photoelectron intensity was measured: carbon (C1s): 260 to 300 eV, nitrogen (N1s: 390 to 410 eV), oxygen (O1s): 525 to 545 eV, fluorine (F1s): 680 to 698 eV, and silicon (2p): 92 to 112 eV. As described above, the profile of elemental ratio in the film depth direction (hereinafter, depth profile) was acquired.

For the spectrum of each element obtained by PAR-XPS in (2) above, the waveform separation of the peaks in the oxygen (O1s) spectrum was further carried out, the peak attributed to the Si—O structure or C—O structure and the peak attributed to the CF×O structure were identified, and the peak attributed to the CF×O structure had a bond energy of 533.5 to 537.5 eV.

In addition, the amount of F atoms as C—F (in terms of amount of substance): A^{F}_{C-F} and the amount of N atoms as C—N (in terms of amount of substance) were calculated based on the F1s spectrum and the N1s spectrum, respectively.

Note that, for the correction of energy reference and the waveform separation, reference was made to the following literature.

M. Toselli et al., Polym Int 52: 1262-1274 (2003) and A. Hawkridge et al., Macromolecules, Vol. 35, No. 17 (2002).

(3) Initial Contact Angle

On the surface of the obtained laminated body, a water droplet of 3 μL was dropped on the cured film side, and the contact angle of water was measured by the droplet method (analysis method: θ/2 method) using a contact angle measuring device (manufactured by Kyowa Interface Science, Inc., DM700).

(4) Wear Resistance Test

Kimwipe Wiper S-200 manufactured by Nippon Paper Crecia, Co., Ltd., 16 sheets of which were stacked on top of each other, was attached to a 15 mm square elastic material (plastic eraser model number 1156SMTR00 manufactured by Maped (France)), and a wear resistance test was carried out applying a load of 200 g, with a stroke of 30 mm, and at 90 r/min (90 back and forth per one minute) to measure the contact angle. Among the numbers of tests where the contact angle was greater than 100°, the maximum number of tests was recorded.

(5) Evaluation of Appearance

The front side (surface on the cured film side) of the obtained laminated body was placed in contact with a black acrylic plate and checked under a three-wavelength tube for the presence or absence of an uneven or foreign substance.

(6) Measurement of Film Thickness

Using the VG Theta Probe analysis software manufactured by Thermo Fisher Scientific, depth profile construction by film thickness calculation and simulation calculation was carried out based on the spectrum of each element obtained in (2) above.

Specifically, in the angle-resolved lens mode, the measurement was carried out from a detection angle of 81.13° to 24.88°, and the depth from the surface was calculated for each detection angle, assuming an information depth of 6 to 7 nm. The film thickness was calculated from the slope of a straight line obtained by plotting the value calculated from the peak area ratio of the substrate-derived signal for each detection angle.

(7) Measurement of Arithmetic Mean Roughness Ra

Using a laser microscope (OLS4000, manufactured by Olympus Corporation), the cured film surface of the laminated body was observed at a magnification of 100 times. The arithmetic mean roughness Ra was evaluated in accordance with JIS B0601. The arithmetic mean roughness Ra was the average value of N=3.

The results measured by the above methods are shown in Table 2 below.

TABLE 2

| | | | | | | Comparative |
|---|---|---|---|---|---|---|
| | | | Example 1 | Example 2 | Example 3 | Example 1 |
| Composition | Liquid type | | One liquid system | One liquid system | One liquid system | One liquid system |
| | Organosilicon compound (A) | | Compound (a1) | Compound (a1) | Compound (a1) | Compound of |
| | | | | | | formula (1) |
| | | | 0.07% | 0.07% | 0.02% | 0.085% |
| | Organosilicon compound (C) | | X-12-5263HP | X-12-5263HP | X-12-5263HP | KBE603 |
| | | | 0.08% | 0.08% | 0.01% | 0.25% |
| XPS | Surface element | F (atom %) | 74.27 | 68.30 | 72.07 | 53.85 |
| | | O (atom %) | 21.52 | 28.17 | 25.71 | 16.39 |

| | Oxygen atoms that are CFxO | 20.99 | 26.39 | 23.33 | 8.66 |
|---|---|---|---|---|---|
| | (atom %) | | | | |
| | A^{F}_{C—F}/A^{N}_{C—N} (@0.5 nm) − | 1828 | 1042 | 1194 | 800 |
| | A^{F}_{C—F}/A^{N}_{C—N} (@1.5 nm) | | | | |
| Base layer | Substrate (s) | Resin | Resin | Resin | Resin |
| | Layer (X) | Antireflection Layer | HC | HC | Antireflection Layer |
| | | (ar) | | | (ar) |
| Initial contact | ° | 116.1 | 114.8 | 115.1 | 113.3 |
| angle | | | | | |
| Wear | Contact angle >100° (times) | >30000 | >30000 | >30000 | <5000 |
| resistance | | | | | |
| Appearance | | ∘ Colorless and | ∘ Colorless and | ∘ Colorless and | x White |
| | | transparent | transparent | transparent | |
| Film | nm | 4.4 | 3.3 | 4.3 | 4.2 |
| thickness | | | | | |
| Arithmetic | nm | 9 | 1.5 | 1.5 | 43 |
| mean | | | | | |
| roughness Ra | | | | | |

### INDUSTRIAL APPLICABILITY

The laminated body including a cured film of the mixed composition of the present invention can be suitably formed into a film for display devices such as touch panel displays, optical elements, semiconductor elements, construction materials, nanoimprint technology, solar cells, window glass of automobiles and buildings, metal products such as cookware, ceramic products such as tableware, automobile components made of plastics, and others, and is industrially useful. It is also preferably used for items of various members around kitchens, bathrooms, washing stands, mirrors, and toilets.

1. A cured film of a mixed composition of an organosilicon compound (A) including a fluoropolyether structure and an organosilicon compound (C) having an amino group or an amine skeleton,
wherein, when elements constituting one side surface (W) of the cured film and amounts thereof are measured by X-ray photoelectron spectroscopy (XPS), the cured film has an F content of 60 atom % or more and an O content of 17 atom % or more.

2. The cured film according to claim 1, wherein, when elements constituting the surface (W) and elemental amounts thereof are measured by PAR-XPS and a spectrum of each element is analyzed, oxygen atoms contained in a CF×O structure are 10 atom % or more relative to all elements, as determined by analyzing a spectrum of oxygen (O1s).

3. The cured film according to claim 1, wherein, when a ratio percentage Q: A^{F}_{C-F}/A^{N}_{C-N}×100 (atom %) of an amount of F atoms as C—F (in terms of amount of substance): A^{F}_{C-F} to an amount of N atoms as C—N (in terms of amount of substance): A^{N}_{C-N} is determined at a depth of 0.5 nm and a depth of 1.5 nm from the surface (W), Q_{0.5nm} (atom %) at a depth of 0.5 nm is 1000 (atom %) or more larger than Q_{1.5nm} (atom %) at a depth of 1.5 nm.

4. The cured film according to claim 1, having a film thickness of less than 15 nm.

5. The cured film according to claim 1, wherein the surface (W) has a surface arithmetic mean roughness Ra of 40 nm or less, as calculated in accordance with JIS B0601.

6. The cured film according to claim 1, wherein a contact angle of water on the surface (W) is 113° or more.

7. A laminated body comprising a substrate (s) and the cured film according to claim 1.

8. The laminated body according to claim 7, wherein the substrate (s) and the cured film are laminated via a layer (X) formed from at least one selected from the group consisting of an acrylic resin, a silicone resin, a styrene resin, a vinyl chloride resin, a polyamide resin, a phenolic resin, an epoxy resin, and SiO₂.

9. A window film or touch panel display comprising the laminated body according to claim 7.
